(19) United States
(12) Patent Application Publication
(10) Pub. No.: US 2026/0091781 A1
(43) Pub. Date: Apr. 2, 2026

(54) RADIO COMMUNICATION AND VEHICLE CONTROL SYSTEM FOR CONTACT AVOIDANCE

(71) Applicant: Innovative Wireless Technologies, Inc., Lynchburg, VA (US)

(72) Inventors: Timothy J. DeChant, Amherst, VA (US); Jason B.E. Jarrett, Lynchburg, VA (US); Robert J. Douglass, Lynchburg, VA (US); David W. Tesdall, Madison Heights, VA (US); Robert Bruce Sanders, Lynchburg, VA (US); Cara M. Stephens, Forest, VA (US)

(21) Appl. No.: 19/351,963

(22) Filed: Oct. 7, 2025

Related U.S. Application Data
(63) Continuation of application No. PCT/US25/45777, filed on Sep. 10, 2025.
(60) Provisional application No. 63/702,542, filed on Oct. 2, 2024.

(51) Int. Cl. B60W 30/09; B60W 10/184; B60W 10/196; B60W 50/00; B60W 50/14; G01S 13/931; G08G 1/16

(52) U.S. Cl. CPC B60W 30/09; B60W 10/184; B60W 10/196; B60W 50/0098; B60W 50/14; G01S 13/931; G08G 1/161; B60W 2554/4029; B60W 2556/45; B60W 2710/18; B60W 2720/106; G01S 2013/93185

(57) ABSTRACT

Described herein are systems and methods capable of performing communication/sensor protocols between mobile devices and vehicles, or between vehicles, and capable of determining when the presence of assets and vehicle(s) together warrants slowing or stopping and subsequently controlling one or more of the vehicle(s) accordingly. The radio communication and vehicle control system includes i) mobile communication device(s), ii) multiple radio communication devices, iii) a command unit, control unit, and optionally a display unit. The systems and methods are capable of communicating ToF information and from that calculating a statistically computed multivariate probability distribution associated with the mobile device to be used to predict, prevent and provide warnings for the person or secondary vehicle/location/equipment from coming into contact with the primary vehicle.

### CROSS-REFERENCE TO RELATED APPLICATIONS

This application is a Continuation of International Application No. PCT/US25/45777 filed Sep. 10, 2025, which application claims priority to and the benefit of the filing date of U.S. Provisional Application No. 63/702,542, filed Oct. 2, 2024, the disclosure of which are hereby incorporated by reference herein in their entireties.

### BACKGROUND OF THE INVENTION

### Field of the Invention

The present invention relates to the field of radio communication and vehicle control systems. More particularly, provided are systems and methods for communicating between mobile communication devices and primary vehicle radio communication devices to detect the presence of mobile communication devices and in response control movement of the primary vehicle, including but not limited to contact avoidance, acceleration, de-acceleration, emergency stopping, and/or steering.

### Description of Related Art

Existing systems are bulky for users and susceptible to environmental interference. The technology described herein allows for smaller mobile devices that can be mounted or worn in more convenient locations to minimize inconvenience to the users.

Existing systems assume perfect sensing as they are directly trying to sense the user with precise coordinates which don't adequately account for error. In real-world scenarios, there are multiple error sources that greatly impact performance of various systems. The technology described herein account for error due to people, vehicles, and the surrounding environment to understand and mitigate the impact on performance of the system.

This approach allows the operator to tune the confidence threshold to better account for errors and address false positives/negatives. Due to the nature of dynamic environments in which the systems are expected to perform with specific expectations, embodiments of the invention take the environment and other dynamic parameters into account by identifying and accounting for error to provide an improved approach to contact avoidance between personnel, vehicles and fixed structures.

### SUMMARY OF THE INVENTION

The radio communication and vehicle control system includes i) one or more or multiple mobile communication devices (e.g., tag, radio, sensor located on one or more person or secondary vehicles or a fixed location or fixed/stationary equipment), ii) a radio communication system comprising multiple radio communication devices (e.g., mounted on a primary vehicle), iii) a command unit, iv) a control unit, and optionally v) a display unit. The system is further configured for communicating ToF (time of flight) information directly or indirectly via TDoA (time difference on arrival), computing multiple polygons (e.g., fixed or dynamic polygons) associated with a fixed or moving vehicle, calculating a statistically computed multivariate probability distribution associated with one or more mobile communication device, computing various points of the multivariate probability distribution, and providing warnings for and/or preventing contact between the person or secondary vehicle or location or equipment and the primary vehicle. The radio communication and vehicle control system includes processing architecture and protocol support to receive multiple radio frequency blinks concurrently for multiple mobile communication device (tag, radio, sensor) support.

According to embodiments of the method, the radio communication and vehicle control system includes at least one mobile communication device (tag, radio, sensor) located, for example, on a person or secondary vehicle that initiates communication by generating a radio frequency blink. The radio communication and vehicle control system receives the mobile communication device frequency blink with a plurality of radio communication devices (e.g., mounted on a primary vehicle) and identifies and selects a subset of the radio communication devices for more accurate communication between the radio communication system and mobile communication devices. The radio communication system performs a two-way ranging (TWR) or time of flight (ToF) protocol between the one or more or each mobile communication device and the selected subset of the plurality of primary vehicle radio communication devices. The system stores in memory a pre-determined, fixed set of polygons with respect to the primary vehicle and calculates another set of dynamic polygons based on the primary vehicle and vehicle movement. The radio communication and vehicle control system calculates a multivariate probability distribution that represents/approximates the mobile communication device and is based on a statistical multivariate vector or rasterized calculation (see, e.g., FIG. 15). The multivariate probability distribution is based on the time of flight information gathered and error associated with the time of flight information and represents a predicted presence of the person relative to the primary vehicle. The multivariate probability distribution does not rely on an actual geographic location or coordinates of the person, nor dimensions of a person, nor velocity or direction of travel of the person. The radio communication and vehicle control system calculates multiple points of the multivariate probability distribution and determines encroachment of any of the points upon any segment/threshold of the fixed or dynamic polygons referenced to the primary vehicle. A determination that one or more of the selected points of the multivariate probability distribution encroaches on any of the segments/thresholds of the fixed or dynamic polygons is an indication that the person is closer to the primary vehicle than desired. To intervene in such situation, control commands to the primary vehicle are initiated and a warning signal to the primary vehicle operator and nearby personnel is generated to avoid the person being too close to the vehicle.

According to embodiments of the invention, various aspects include: Aspect 1A, which is a radio communication and vehicle control system, comprising: at least one mobile communication device; a plurality of radio communication devices in association with a primary vehicle; a command unit comprising storage and processing capabilities for: i) communication between the plurality of radio communication devices; ii) performing an approximation of the at least one mobile communication device and selecting one or more points therein; iii) preparing fixed and/or dynamic polygons relative to the primary vehicle and selecting one or more segments thereof; and iv) comparing one or more of the selected points with one or more of the segments to determine point-segment encroachment or non-encroachment; a control unit capable of operable communication with the command unit and one or more controls of the primary vehicle, the control unit configured to: cause braking of the primary vehicle; release braking of the primary vehicle; and/or accelerate the primary vehicle.

Aspect 2A is the system of Aspect 1A, further comprising an alert display unit in operable communication with the command unit and the control unit.

Aspect 3A is the system of Aspect 1A or 2A, wherein: the approximation is a statistical approximation; the one or more selected points are statistical points; and the approximation comprises a multivariate probability distribution approximating the at least one mobile communication device.

Aspect 4A is the system of any of Aspects 1A-3A, wherein: the point-segment encroachment or non-encroachment determination comprises comparing the one or more selected statistical points, which are statistical points of the multivariate probability distribution, with a threshold.

Aspect 5A is the system of any of Aspects 1A-4A, wherein: the encroachment is determined by non-compliance with the threshold; or the non-encroachment is determined by compliance with the threshold.

Aspect 6A is the system of any of Aspects 1A-5A, wherein: based on the non-compliance with the threshold, the command unit is configured to communicate with the control unit to slow or stop the primary vehicle.

Aspect 7A is the system of any of Aspects 1A-6A, wherein: based on the compliance with the threshold, the command unit is configured to communicate with the control unit to accelerate or release a brake of the primary vehicle.

Aspect 8A is the system of any of Aspects 1A-7A, wherein: the braking involves motor braking of the primary vehicle; the braking is capable of decelerating or stopping the primary vehicle; the braking involves an emergency brake of the primary vehicle; and/or the release involves releasing a brake, the motor braking, or the emergency brake.

Aspect 9A is the system of any of Aspects 1A-8A, wherein the braking or the release involves one or more algorithm(s).

Aspect 10A is the system of any of Aspects 1A-9A, wherein: the algorithm(s) for motor braking, decelerating, releasing the motor braking or accelerating compare multiple statistically computed points to the segments of the dynamic polygons to ensure the multiple statistically computed points do not encroach upon one or more segments of the fixed polygons; and the control unit enables engagement of an emergency brake of the primary vehicle in response to one or more of the statistically computed points encroaching upon one or more segment of the fixed polygons.

Aspect 11A is the system of any of Aspects 1A-10A, wherein the command unit: is capable of computing multiple polygons by extending the fixed polygons as the primary vehicle changes direction and/or velocity.

Aspect 12A is a contact avoidance system comprising: a mobile communication device capable of being disposed on a first asset; a radio communication system comprising a plurality of sensors capable of being disposed on a primary vehicle; a control unit; and a command unit configured to: execute a two-direction two-way ranging or time-of-flight protocol between a subset of the plurality of sensors and the mobile communication device; compute a multivariate probability distribution approximating the first asset, compare calculated points of the multivariate probability distribution with a threshold, and determine threshold non-compliance; and based on the threshold non-compliance, communicate with the control unit to slow or stop the primary vehicle.

Aspect 13A is the contact avoidance system of Aspect 12A, wherein: one or more of the plurality of sensors are capable of listening for and performing ongoing communications with the mobile communication device; and the mobile communication device is capable of generating radio frequency messages or blinks for reception by the plurality of sensors.

Aspect 14A is the contact avoidance system of Aspect 12A or 13A, wherein: the plurality of sensors comprises at least four sensors configured to communicate time-of-flight (ToF) information with time difference of arrival (TDoA) to the command unit.

Aspect 15A is the contact avoidance system of any of Aspects 12A-14A, wherein the command unit: is capable of calculating an estimated ToF with TDoA of TWR (two way ranging) timestamps; is capable of predicting error of estimated ToF with TDoA based on TWR metadata; is capable of combining the predicted error with the estimated ToF with TDoA to compute a multivariate probability distribution representing the probability distribution of the location of the at least one mobile communication device.

Aspect 16A is the contact avoidance system of any of Aspects 12A-15A, wherein the command unit further comprises one or more of: an algorithm that computes a point with maximum likelihood of the multivariate probability distribution; or an algorithm to compute points on, within, of, or from probability contour lines of the multivariate probability distribution that delineates a specific probability; or an algorithm to stochastically choose points on, within, of, or from the multivariate probability distribution.

Aspect 17A is the contact avoidance system of any of Aspects 12A-16A, wherein the command unit comprises storage and processing capabilities for: preparing fixed and/or dynamic polygons relative to the primary vehicle and selecting one or more segments thereof; and comparing one or more of the calculated points of the multivariate probability distribution with one or more of the segments to determine point-segment encroachment or point-segment non-encroachment.

Aspect 18A is the contact avoidance system of any of Aspects 12A-17A, wherein the command unit comprises storage and processing capabilities for: initiating motor de-acceleration in response to point-segment encroachment of warning policy polygons; initiating motor acceleration in response to point-segment non-encroachment; initiating emergency braking in response to point-segment encroachment of stopping policy polygons; initiating locking of the primary vehicle by way of an emergency brake in response to point-segment encroachment of stopped policy polygons; and/or de-activating the emergency brake in response to no point-segment encroachment of the stopping or stopped policy polygons.

Aspect 19A is the contact avoidance system of any of Aspects 12A-18A, wherein the primary vehicle comprises a non-articulating frame or an articulating frame, with or without moving components.

Aspect 20A is the contact avoidance system of any of Aspects 12A-19A, wherein the mobile communication device is configured for mounting on a person or on a secondary vehicle.

According to embodiments of the invention, various aspects also include: Aspect 1, which is a contact avoidance system comprising: at least one mobile communication device disposed on a first asset (optionally a person or a secondary vehicle); a radio communication system comprising a plurality of radio communication devices (sensors) disposed on a second asset (optionally a primary vehicle), a command unit and a control unit; wherein the command unit is configured to: i) execute a two-direction two-way ranging or time-of-flight protocol between a subset of the plurality of sensors and one or more of the mobile communication devices; ii) compute a multivariate probability distribution representing and/or approximating a first asset, compare calculated points of the multivariate probability distribution with a threshold, and determine threshold non-compliance; and iii) based on the non-compliance with the threshold, communicate with the control unit to slow or stop the primary vehicle. In embodiments, the multivariate probability distribution represents and/or approximates the first asset by approximating a boundary of the first asset.

Aspect 2 is a radio communication and primary vehicle control system, comprising: at least one mobile communication device; a plurality of radio communication devices; a command unit comprising storage and processing capabilities for i) communication between the plurality of radio communication devices, ii) for performing computation of one or more multivariate probability distribution(s) representing and/or approximating one or more of a plurality of mobile devices, iii) for performing computation of fixed and dynamic polygons relative to a primary vehicle, and iv) for performing computation of statistical points of the multivariate probability distribution; a control unit for communication with the command unit and electrical controls/interfaces of the primary vehicle to de-accelerate, stop or allow acceleration of the primary vehicle, wherein the control unit is configured i) to algorithmically motor brake the primary vehicle, ii) to algorithmically release the motor brake of the primary vehicle, iii) to algorithmically motor brake the primary vehicle to a stop, iv) to engage an emergency brake of the primary vehicle, when one or more of the statistically computed points encroaches upon a segment of the fixed polygons; and a display unit in operable communication with the command and control units configured to display alert messages or notifications. In embodiments, the one or more multivariate probability distributions represents one or more mobile device by approximating the one or more mobile device and/or by approximating a boundary of the one or more mobile device.

Aspect 3 is the contact avoidance system or the radio communication and primary vehicle control system of Aspect 1 or 2, wherein the command unit is configured to perform communications with the plurality of radio communication devices of the primary vehicle, the control unit, and the display unit.

Aspect 4 is the system of any of Aspects 1-3, wherein the command unit comprises one or more microcontroller.

Aspect 5 is the system of any of Aspects 1-4, wherein the one or more microcontroller controls slot timing of transmit and receive.

Aspect 6 is the system of any of Aspects 1-5, wherein the command unit comprises a radio communication hub for wired communication to one or more or each of the plurality of radio communication devices, the control unit and/or the display unit.

Aspect 7 is the system of any of Aspects 1-6, wherein the command unit comprises power distribution to the display unit and one or more or each of the plurality of radio communication devices.

Aspect 8 is the system of any of Aspects 1-7, wherein the command unit comprises an inertial measurement unit.

Aspect 9 is the system of any of Aspects 1-8, wherein the command unit comprises one or more or multiple wireless diagnostics links.

Aspect 10 is the system of any of Aspects 1-9, wherein the command unit comprises one or more volatile and/or non-volatile memory, optionally to store information for system operation.

Aspect 11 is the system of any of Aspects 1-10, wherein one or more of the plurality of radio communication devices are capable of listening for the at least one mobile communication device.

Aspect 12 is the system of any of Aspects 1-11, wherein one or more of the plurality of radio communication devices are capable of performing ongoing communications with the at least one mobile communication device.

Aspect 13 is the system of any of Aspects 1-12, wherein one or more of the plurality of radio communication devices further comprise one or more or all of the following: a microprocessor, optionally to control sub-slot timing of transmit and receive and/or store an ID in non-volatile memory and/or with specific message content; and/or a radio transceiver for special signaling and a high precision counter to determine the precise time a signal is transmitted or received; and a broadband antenna, optionally designed to support the broad frequency range required by the radio transceiver; and/or a ground plane, optionally designed to improve antenna propagation; and/or visual indicators, such as for communicating information.

Aspect 14 is the system of any of Aspects 1-13, wherein the at least one mobile communication device generates radio frequency messages or blinks for reception by the plurality of radio communication devices.

Aspect 15 is the system of any of Aspects 1-14, wherein the plurality of radio communication devices are mounted on a plurality of primary and/or secondary vehicles.

Aspect 16 is the system of Aspect 15, wherein one or more or the plurality of radio communication devices comprise one or more or all the following: a microprocessor, optionally that sets own timing (autonomous) and has a pre-determined schedule of slot communication with the system, stores an ID in non-volatile memory and/or specific message content; and/or a radio transceiver, optionally for special signaling and a high precision counter to determine the precise ToF directly or indirectly with TDoA of a signal is transmitted or received; and/or a broadband antenna, optionally designed to support the broad frequency range required by the radio transceiver; and/or a communication port, optionally for charging, programming and/or enabling or disabling the mobile communication device; and/or warning capabilities, optionally for alerts and/or notifications, optionally via audible and/or visual circuits.

Aspect 17 is the system of any of Aspects 1-16, wherein the command unit further comprises an over-the-air (OTA) protocol.

Aspect 18 is the system of aspect 17, wherein the command unit is configured to process over-the-air metadata between the plurality of radio communication devices and a plurality of mobile communication devices.

Aspect 19 is the system of Aspect 18, wherein the command unit is configured to correlate present conditions with compiled historic records to estimate accuracy and the over-the-air (OTA) protocol and computation of a multivariate probability distribution.

Aspect 20 is the system of any of Aspects 1-19, wherein the command unit, radio communication devices and/or mobile communication devices further comprise one or more or all the following: the over the air protocol; and/or a method for a plurality of mobile communication devices generating indiscriminate radio frequency pulses; and/or primary vehicle radio communication devices reporting they heard the at least one mobile communication device along with metadata; and/or runs error predictor to determine predicted error of ranging between the at least one mobile communication device and the plurality of radio communication devices of the primary vehicle; and/or the command unit prioritizing the top four radio communication devices by “most accurate” primary vehicle radio metadata; and/or selecting at least one of the plurality of radio communication devices with the least predicted error for communication with the at least one mobile communication device; and/or message transfer between the strongest of the plurality of radio communication devices and the at least one mobile communication device with content and instructions for two-way ranging; and/or response from the at least one mobile communication device with 802.15.4z double-sided two-way ranging messages to at least four of the plurality of radio communication devices selected by the command unit; and/or at least four radio communication devices communicate ToF information directly or indirectly with TDoA to the command unit for processing.

Aspect 21 is the system of any of Aspects 1-20, wherein the command unit further comprises one or more or all the following: Means for computing a digital twin(s) for each of the at least one mobile communication device; and/or Means for computing a digital twin(s) for each of the plurality of radio communication devices of the primary vehicle; and/or Means for anticipating OTA schedule for at least one mobile communication device and scheduling the at least four of the plurality of radio communication devices within the OTA schedule.

Aspect 22 is the system of any of Aspects 1-21, wherein the command unit further comprises one or more or all the following: A method for taking the timestamps and metadata returned from TWR (two way ranging) by each of the plurality of radio communication devices; and/or Calculating an estimated ToF (time of flight) directly or indirectly with TDoA (time difference on arrival) of the TWR timestamps; and/or Predict error of estimated ToF directly or indirectly with TDoA based on the TWR metadata; and/or Combining the predicted error with the estimated ToF directly or indirectly with TDoA to compute a multivariate probability distribution representing the probability distribution of the location of the at least one mobile communication device.

Aspect 23 is the system of any of Aspects 1-22, wherein the command unit further comprises one or more or all the following: An algorithm that computes the point with maximum likelihood of the multivariate probability distribution; or An algorithm to compute points on, within, of, or from the probability contour lines of the multivariate probability distribution that delineates a specific probability; or An algorithm to stochastically choose points on, within, of, or from the multivariate probability distribution; or Any other methods for computing points on, within, of, or from the multivariate probability distribution.

Aspect 24 is the system of any of Aspects 1-23, wherein the command unit further comprises one or more or all of the following: A system configured with fixed polygons relative to the primary vehicle where the primary vehicle is stopped to avoid contact with the at least one mobile communication device; and/or Multiple polygons based on locations relative to the vehicle; and/or System monitors the primary vehicle to determine direction; and/or As the primary vehicle changes direction, algorithm updates the polygons relative to the primary vehicle.

Aspect 25 is the system of any of Aspects 1-24, wherein the control unit further comprises one or more or all of the following: A system that dictates throttle settings; and/or A system that monitors the primary vehicle to determine velocity; and/or A system that monitors the primary vehicle to determine direction; and/or A system that computes multiple polygons relative to the vehicle; and/or An algorithm that calculates the polygons relative to the primary vehicle by extending the fixed polygons, optionally as the primary vehicle changes direction and/or velocity.

Aspect 26 is the system of any of Aspects 1-25, wherein the command unit is further configured to compare statistically computed points with segments of the fixed and/or dynamic polygons.

Aspect 27 is the system of any of Aspects 1-26, wherein the command unit and/or control unit further comprises one or more or all of the following: A method wherein response to any of the statistically computed points encroaching on segments of the warning policy polygons, a motor de-acceleration sequence initiates; and/or In response to all of the statistically computed points no longer being detected as encroaching on segments of the warning policy polygons, the system initiates a motor acceleration sequence; and/or In response to any of the statistically computed points encroaching on segments of the stopping policy polygons, the system initiates an emergency braking sequence; and/or In response to any of the points computed of the multivariate probability distribution encroaching on any of the segments of the stopped policy polygons, the system keeps the vehicle “locked” via the emergency brakes; and/or In response to all of the statistically computed points no longer being detected as encroaching on segments of the stopping or stopped policy polygons, the system de-activates the emergency brake, and optionally includes operator intervention.

Aspect 28 is the system of any of Aspects 1-27, wherein the control unit: communicates with the command unit and the display unit; and/or Interfaces with one or more controls of the primary vehicle, optionally to manage operation of the primary vehicle using redundant methods; and/or Senses the one or more controls of the primary vehicle; and/or Assists with system configuration and diagnostics; and/or Generates status messages and warning indicators; and/or Comprises a measuring acceleration sensor to confirm primary vehicle acceleration and de-acceleration; and/or Is configured to perform a method to detect if the mechanical emergency braking system effectively stopped or is stopping the primary vehicle by utilizing detailed measurements from an onboard accelerometer.

Aspect 29 is the system of any of Aspects 1-28, wherein the control unit further comprises methods to redundantly control various functions of the primary vehicle.

Aspect 30 is the system of Aspect 29, wherein the methods include one or more or all of the following: A method to limit velocity of the primary vehicle through motor braking; and A method to stop the primary vehicle through motor braking; and A method to stop the primary vehicle through emergency braking; and A method to stop the vehicle by removing power.

Aspect 31 is the system of any of Aspects 1-30, wherein the control unit further comprises methods to monitor various functions of the primary vehicle including one or more or all of the following: A method to detect direction of primary vehicle travel; and/or A method to sense the throttle level; and/or A method to sense direction and angle of steering.

Aspect 32 is the system of any of Aspects 1-31, wherein the display unit comprises one or more or all of the following: A microcontroller that communicates with the command unit and the control unit; and/or An LCD that provides a user interface to the primary vehicle operator; and Menu buttons for primary vehicle operator direct interface; and/or Override button for primary vehicle operator direct interface; and/or A maintenance lock switch for primary vehicle operator direct interface; and/or A radio communication device for communication with the operator's mobile communication device and a plurality of other mobile communication devices; and/or A method for generating warnings.

Aspect 33 is the system of any of Aspects 1-32, wherein the display unit further comprises a user interface including one or more or all of the following: A method for pairing the mobile communication devices with the primary vehicle system; and/or A method for primary vehicle system configuration and diagnostics; and/or Other methods for user interaction.

Aspect 34 is the system of any of Aspects 1-33, wherein one or more of the command unit, control unit, and radio communication devices further comprises power and/or communication monitoring.

Aspect 35 is the system of Aspect 34, wherein the power and/or communication monitoring is present for one or more or each primary vehicle system component and/or between primary vehicle system components to ensure proper system operation.

Aspect 36 is the system of any of Aspects 1-35, wherein the command unit and/or control unit further comprises components and methods that determine if the wiring between the command unit and control unit to the primary vehicle are intentionally or unintentionally modified.

Aspect 37 is the system of any of Aspects 1-36, wherein the command unit and/or control unit comprise one or more or all of the following: An emergency stop circuit that detects tampering; and/or A variable throttle slowdown circuit that detects tampering; and/or A method for calibration and compensation of electrical differences between vehicles providing a consistent return to velocity movement; and/or Automatic error codes for tampering and equipment failure sent to display unit.

Aspect 38 is the system of any of Aspects 1-37, wherein the one or more of the radio communication devices further comprises an enclosure.

Aspect 39 is the system of any of Aspects 1-38, wherein the enclosure is designed for durability in the rugged environment while allowing radio signals and light to pass for proper radio communication and alerts.

Aspect 40 is the system of any of Aspects 1-39, wherein the command unit further comprises the ability to store historical metadata.

Aspect 41 is the system of Aspect 40, wherein the command unit is capable of: storing information from one or more or each of the radio communication devices and/or one or more or each of the mobile communication device blinks and TWR; and/or compiling the combined data from each of a plurality of primary vehicle communication devices and a plurality of mobile communication device blinks and TWR to determine direction and velocity.

Aspect 42 is the system of any of Aspects 1-41, wherein the command unit further comprises methods for configuration management to allow for various primary vehicle types comprising: A non-articulating frame with or without moving components; and/or An articulating frame with or without moving components.

Aspect 43 is the system of any of Aspects 1-42, wherein the mobile communication device is configured for mounting on a person or on one or more secondary vehicles.

Aspect 44 is the system of any of Aspects 1-43, wherein the radio communication devices are configured for mounting on a primary vehicle, optionally mounted in various locations and/or optionally configured and/or optionally calibrated to ensure coordinated communication with the at least one mobile communication device and/or configured and/or calibrated to perform polygon computation and generation.

Aspect 45 is the system of any of Aspects 1-44, wherein the display unit is configured to allow a user to pair the at least one mobile communication devices.

Aspect 46 is the system of any of Aspects 1-45, wherein the algorithm to algorithmically motor brake the primary vehicle (optionally for de-acceleration) compares the multiple statistically computed points to segments of the computed dynamic polygons to ensure the multiple statistically computed points do not encroach upon one or more segments of the fixed polygons relative to the primary vehicle.

Aspect 47 is the system of any of Aspects 1-6, wherein the algorithm to algorithmically release the motor brake of the primary vehicle (optionally for allowance of acceleration) compares the multiple statistically computed points relative to segments of the computed dynamic polygons to ensure the multiple statistically computed points do not encroach upon one or more segments of the fixed polygons relative to the primary vehicle.

Aspect 48 is the system of any of Aspects 1-47, wherein the algorithm to algorithmically motor brake the primary vehicle (optionally to a stop, optionally without engaging an emergency brake) compares the statistically computed points relative to segments of the computed dynamic polygons to ensure the multiple statistically computed points do not encroach upon one or more segments of the fixed polygons.

Aspect 49 is the system of any of Aspects 1-48, wherein the control unit enables engagement of an emergency brake of the primary vehicle when one or more of the statistically computed points encroaches upon one or more segment of the fixed polygons.

Aspect 50 is the system of any of Aspects 1-49, further configured to send alerts to an operator of the primary vehicle based on any one or more of the motor brake or emergency brake actions.

Aspect 51 is the system of any of Aspects 1-50, further configured to send alerts to mobile communication device based on any one or more of the motor brake or emergency brake actions.

Aspect 52 is a radio communication and primary vehicle control system, comprising: at least one mobile communication device for mounting on a person or on one or more secondary vehicles, such as a plurality of mobile communication devices mounted on one or more person and/or one or more secondary vehicles; a plurality of radio communication devices (sensors) for mounting on a primary vehicle, optionally mounted in various locations and configured and calibrated to ensure coordinated communication with the at least one of the mobile communication devices and configured and calibrated to perform polygon computation and generation; a command unit comprising storage and processing capabilities for coordinated communication between the primary vehicle's plurality of sensors and capable of performing algorithm computation of a multivariate probability distribution representing each of the plurality of mobile communication devices along with computation of fixed and dynamic polygons relative to the primary vehicle; a control unit for communication with the command unit and electrical controls/interfaces of the primary vehicle to de-accelerate, stop or allow acceleration of the primary vehicle; a display unit in operable communication with the command and control units, to provide an “interface with a user to” pair the at least one mobile communication devices and display alert messages or notifications based on any of the motor brake or emergency brake actions of (i), (j), (k) or (l); means to compute one or more multivariate probability distribution; means to compute multiple statistical points of the multivariate probability distribution for comparison with one or more segments of the fixed (e.g., preset) and dynamic polygons (e.g., non-preset) relative to the primary vehicle; means to store the fixed polygons and to compute the dynamic polygons relative to the primary vehicle; means to algorithmically motor brake the primary vehicle for de-acceleration based on an algorithm that compares the multiple statistically computed points relative to segments of the computed dynamic polygons to ensure the multiple statistically computed points do not encroach upon one or more segments of the fixed polygons relative to the primary vehicle; means to algorithmically release the motor brake of the primary vehicle for allowance of acceleration based on an algorithm that compares the multiple statistically computed points relative to segments of the computed dynamic polygons to ensure the multiple statistically computed points do not encroach upon one or more segments of the fixed polygons relative to the primary vehicle; means to algorithmically motor brake the primary vehicle to a stop, optionally without engaging an emergency brake, based on an algorithm that compares the statistically computed points relative to segments of the computed dynamic polygons to ensure the multiple statistically computed points do not encroach upon one or more segments of the fixed polygons; means to engage an emergency brake of the primary vehicle when one or more of the statistically computed points encroaches upon one or more segment of the fixed polygons; means to send alerts to an operator of the primary vehicle based on any one or more of the motor brake or emergency brake actions of (i), (j), (k) or (l); means to send alerts to one or more of the at least one mobile communication devices based on any of the motor brake or emergency brake actions of (i), (j), (k) or (l).

Aspect 53 is the system of any of Aspects 1-52, wherein the command unit is configured to perform wired communications with the plurality of radio communication devices of the primary vehicle, the control unit, and the display unit, and includes storage and processing for multiple protocols and algorithms, and further comprises one or more or all the following: A microcontroller that controls slot timing of transmit and receive; A radio communication hub for wired communication to each of the plurality of radio communication devices of the primary vehicle, the control unit and the display unit; and Power distribution to the display unit and each of the plurality of radio communication devices of the primary vehicle; Optionally, an inertial measurement unit; Multiple wireless diagnostics links; and Volatile and non-volatile memory to store information for system operation.

Aspect 54 is the system of any of Aspects 1-53, wherein the plurality of radio communication devices of the primary vehicle are capable of initially listening for the at least one mobile communication device and capable of performing ongoing communications with the at least one mobile communication device and further comprise one or more or all of the following: A microprocessor to control sub-slot timing of transmit and receive, stores an ID in non-volatile memory along with specific message content; and A radio transceiver for special signaling and a high precision counter to determine the precise time a signal is transmitted or received; and a broadband antenna designed to support the broad frequency range required by the radio transceiver; and a ground plane designed to improve antenna propagation; and visual indicators for communicating information.

Aspect 55 is the system of any of Aspects 1-54, wherein the at least one mobile communication device generates radio frequency messages or blinks for reception by the plurality of radio communication devices, optionally mounted on a plurality of primary and secondary vehicles and further comprises one or more or all the following: A microprocessor that sets own timing (autonomous) and has a pre-determined schedule of slot communication with the system, stores an ID in non-volatile memory along with specific message content; and A radio transceiver for special signaling and a high precision counter to determine the precise ToF directly or indirectly with TDoA of a signal is transmitted or received; and a broadband antenna designed to support the broad frequency range required by the radio transceiver; and a communication port for charging, programming and enabling or disabling the mobile communication device; and warning capabilities for alerts and notifications via audible or visual circuits.

Aspect 56 is the system of any of Aspects 1-55, wherein the command unit further comprises an over-the-air (OTA) protocol with the capability for processing over-the-air metadata between the plurality of radio communication devices and a plurality of mobile communication devices to correlate present conditions with compiled historic records to estimate accuracy and improve the over-the-air (OTA) protocol and computation of a multivariate probability distribution.

Aspect 57 is the system of any of Aspects 1-56, wherein the command unit, radio communication devices and mobile communication devices further comprise one or more or all the following: The over the air protocol; and A method for a plurality of mobile communication devices generating indiscriminate radio frequency pulses; and All primary vehicle radio communication devices reporting they heard the at least one mobile communication device along with metadata; and Runs error predictor to determine predicted error of ranging between the at least one mobile communication device and the plurality of radio communication devices of the primary vehicle; and The command unit prioritizing the top four radio communication devices by “most accurate” primary vehicle radio metadata; and Selecting at least one of the plurality of radio communication devices with the least predicted error for communication with the at least one mobile communication device; and Message transfer between the strongest of the plurality of radio communication devices and the at least one mobile communication device with content and instructions for two-way ranging; and Response from the at least one mobile communication device with 802.15.4z double-sided two-way ranging messages to at least four of the plurality of radio communication devices selected by the command unit; and At least four radio communication devices communicate ToF directly or indirectly with TDoA information to the command unit for processing.

Aspect 58 is the system of any of Aspects 1-57, wherein the command unit further comprises one or more or all the following: Means for computing digital twin(s) for each of the at least one mobile communication device; and Means for computing digital twin(s) for each of the plurality of radio communication devices of the primary vehicle; and Means for anticipating OTA schedule for at least one mobile communication device and scheduling the at least four of the plurality of radio communication devices within the OTA schedule.

Aspect 59 is the system of any of Aspects 1-58, wherein the command unit further comprises one or more or all the following: A method for taking the timestamps and metadata returned from TWR by each of the plurality of radio communication devices; and Calculating an estimated ToF directly or indirectly with TDoA of the TWR timestamps; and Predict error of estimated ToF directly or indirectly with TDoA based on the TWR metadata; and Combining the predicted error with the estimated ToF directly or indirectly with TDoA to compute a multivariate probability distribution representing the probability distribution of the location of the at least one mobile communication device.

Aspect 60 is the system of any of Aspects 1-59, wherein the command unit further comprises one or more or all the following: an algorithm that computes the geometric center of the multivariate probability distribution; or an algorithm to compute points on, within, of, or from the probability contour lines of the multivariate probability distribution that delineates a specific probability; or an algorithm to stochastically choose points on, within, of, or from the multivariate probability distribution; or any other methods for computing points on, within, of, or from the multivariate probability distribution.

Aspect 61 is the system of any of Aspects 1-60, wherein the command unit further comprises one or more or all of the following: a system configured with fixed polygons relative to the primary vehicle where the primary vehicle is stopped to avoid contact with the at least one mobile communication device; and multiple polygons based on locations relative to the vehicle; and system monitors the primary vehicle to determine direction; and As the primary vehicle changes direction, algorithm updates the polygons relative to the primary vehicle.

Aspect 62 is the system of any of Aspects 1-61, wherein the control unit further comprises one or more or all of the following: a system that dictates throttle settings; and a system that monitors the primary vehicle to determine velocity; and a system that monitors the primary vehicle to determine direction; and a system that computes multiple polygons relative to the vehicle; and as the primary vehicle changes direction and/or velocity, algorithm calculates the polygons relative to the vehicle by extending the previously claimed fixed polygons.

Aspect 63 is the system of any of Aspects 1-62, wherein the command unit further comprises a method to compare statistically computed points with segments of the fixed and dynamic polygons relative to the vehicle.

Aspect 64 is the system of any of Aspects 1-63, wherein the command unit and control unit further comprises one or more or all of the following: a method wherein in response to any of the statistically computed points encroaching on segments of the warning policy polygons, a motor de-acceleration sequence initiates; and in response to all of the statistically computed points no longer being detected as encroaching on segments of the warning policy polygons, the system initiates a motor acceleration sequence; and in response to any of the statistically computed points encroaching on segments of the stopping policy polygons, the system initiates an emergency braking sequence; and in response to any of the points computed of the multivariate probability distribution encroaching on any of the segments of the stopped policy polygons, the system keeps the vehicle “locked” via the emergency brakes; and in response to all of the statistically computed points no longer being detected as encroaching on segments of the stopping or stopped policy polygons, the system de-activates the emergency brake, and optionally includes operator intervention.

Aspect 65 is the system of any of Aspects 1-64, wherein the control unit: communicates with the command unit and the display unit; and/or Interfaces with one or more controls of the primary vehicle to manage operation of the primary vehicle using redundant methods; and/or Senses the one or more controls of the primary vehicle; and/or assists with system configuration and diagnostics; and/or generates status messages and warning indicators; and/or comprises a measuring acceleration sensor to confirm primary vehicle acceleration and de-acceleration; and/or is configured to perform a method to detect if the mechanical emergency braking system effectively stopped or is stopping the primary vehicle by utilizing detailed measurements from an onboard accelerometer.

Aspect 66 is the system of any of Aspects 1-65, wherein the control unit further comprises methods to redundantly control various functions of the primary vehicle including one or more or all of the following: a method to limit velocity of the primary vehicle through motor braking; and a method to stop the primary vehicle through motor braking; and A method to stop the primary vehicle through emergency braking; and a method to stop the vehicle by removing power.

Aspect 67 is the system of any of Aspects 1-66, wherein the control unit further comprises methods to monitor various functions of the primary vehicle including one or more or all of the following: a method to detect direction of primary vehicle travel; and a method to sense the throttle level; and a method to sense direction and angle of steering.

Aspect 68 is the system of any of Aspects 1-67, further comprising a display unit including one or more or all of the following: a microcontroller that communicates with the command unit and the control unit; and An LCD that provides a user interface to the primary vehicle operator; and menu buttons for primary vehicle operator direct interface; and override button for primary vehicle operator direct interface; and a maintenance lock switch for primary vehicle operator direct interface; and a radio communication device for communication with the operator's mobile communication device and a plurality of other mobile communication devices; and a method for generating warnings.

Aspect 69 is the system of any of Aspects 1-68, wherein the display unit further comprises a user interface including one or more or all of the following: a method for pairing one or more of the mobile communication devices with the primary vehicle system; and a method for primary vehicle system configuration and diagnostics; and other methods for user interaction.

Aspect 70 is the system of any of Aspects 1-69, wherein the command unit, control unit, and radio communication devices further comprises power and communication monitoring on each primary vehicle system component and between primary vehicle system components to ensure proper system operation.

Aspect 71 is the system of any of Aspects 1-70, wherein the command unit and/or control unit further comprises components and methods that determine if the wiring between the command unit and control unit to the primary vehicle are intentionally or unintentionally modified comprising one or more or all of the following: an emergency stop circuit that detects tampering; and a variable throttle slowdown circuit that detects tampering; and a method for calibration and compensation of electrical differences between vehicles providing a consistent return to velocity movement; and automatic error codes for tampering and equipment failure sent to display unit.

Aspect 72 is the system of any of Aspects 1-71, wherein the plurality of radio communication devices further comprises an enclosure designed for durability in the rugged environment while allowing radio signals and light to pass for proper radio communication and alerts.

Aspect 73 is the system of any of Aspects 1-72, wherein the command unit further comprises the ability to store historical metadata for analysis comprising: the ability to store information from each of the plurality of primary vehicle communication devices and a plurality of mobile communication device blinks and TWR; and/or compile the combined data from each of the plurality of primary vehicle communication devices and the plurality of mobile communication device blinks and TWR to determine direction and velocity.

Aspect 74 is the system of any of Aspects 1-73, wherein the command unit further comprises methods for configuration management to allow for various primary vehicle types comprising: a non-articulating frame with or without moving components; and/or an articulating frame with or without moving components.

Aspect 75 is a method comprising or implementing any one or more features of Aspects 1-74, either individually or in any combination.

### BRIEF DESCRIPTION OF THE DRAWINGS

The accompanying drawings illustrate certain aspects of implementations of the present disclosure, and should not be construed as limiting. Together with the written description, the drawings serve to explain certain principles of the disclosure.

FIG. 1 is a diagram of a radio communication and vehicle control system according to embodiments of the invention.

FIG. 2 is a diagram showing a primary vehicle 27 mounted radio communication system comprised of multiple radio communication devices 25a-j, a command unit 23, a control unit 24, and a display unit 26.

FIG. 3 is a diagram showing the primary vehicle 27 and associated system components along with an example of radio communication coverage that are a function of the radios and the environment.

FIG. 4 is a diagram showing exemplary fixed polygons 40a-c according to embodiments of methods of the invention.

FIG. 5 is a diagram showing exemplary dynamic polygons 41a-l and 42a-l according to embodiments of methods of the invention.

FIG. 6 is a diagram showing an exemplary command unit 23 of a radio communication and vehicle control system according to embodiments of the invention.

FIG. 7 is a diagram showing an exemplary control unit 24 of a radio communication and vehicle control system according to embodiments of the invention.

FIG. 8 is a diagram showing various components of an exemplary radio communication device (sensor) 25 of a radio communication and vehicle control system according to embodiments of the invention.

FIG. 9 is a diagram showing various components of an exemplary display unit 26 of a radio communication and vehicle control system according to embodiments of the invention.

FIG. 10 is a diagram showing various components of an exemplary mobile communication device 21 of a radio communication and vehicle control system according to embodiments of the invention.

FIG. 11 is a diagram showing an exemplary multivariate probability distribution 225 and calculated points 227a-d according to embodiments of methods of the invention.

FIG. 12 is a flowchart showing an exemplary method embodiment of the invention for calculation of point(s) of the multivariate probability distribution.

FIG. 13 is a flowchart showing an exemplary point-segment test according to method embodiments of the invention.

FIG. 14 is a flowchart showing representative two-way ranging steps of protocols according to method embodiments of the invention, as well as methods that can be employed by radio communication and vehicle control systems according to embodiments of the invention.

FIG. 15 is a flow chart with corresponding diagrams illustrating statistical computation of an exemplary multivariate probability distribution according to embodiments of the invention.

### DETAILED DESCRIPTION OF VARIOUS EMBODIMENTS OF THE INVENTION

Reference will now be made in detail to various illustrative implementations of embodiments of the invention. It is to be understood that the following discussion of implementations is not intended to be limiting.

(System & Method) The first aspect of the invention is a radio communication and vehicle control system and method for communicating between mobile communication devices and primary vehicle radio communication devices to detect the presence of mobile communication devices. Upon detection of the probability of the mobile communication device's undesired presence, the radio communication and vehicle control system and method effects change on the vehicle controls for various movements of the primary vehicle including contact avoidance, acceleration, de-acceleration, emergency stopping, and/or steering. The mobile communication devices are mounted or worn by any object including people, fixed or mobile equipment or fixed locations and are used to interact with the radio communication devices on a primary vehicle to monitor proximity between one or more of the people and the radio communication devices on the primary vehicle, or between one or more fixed or mobile equipment and the radio communication devices on the primary vehicle, and/or between one or more fixed locations and the radio communication devices on the primary vehicle.

(System & Methods Include) The system includes mobile communication devices for mounting on persons, secondary vehicles, or fixed locations, a plurality of radio communication devices on primary vehicle, a command unit with sufficient storage and processing capabilities for coordinated system communication, a control unit for communication with the command unit and the primary vehicle electrical interfaces, a display unit for interfacing with the command and control units, means to process metadata for improved over-the-air (OTA) communication, means to perform OTA communications between mobile communication devices and primary vehicle radio communication devices, means to compute digital twins for every system mobile and radio communication device, means to compute one or more multivariate probability distribution representing one or more mobile communication devices, means to compute statistical points of the multivariate probability distribution, means to store preset fixed polygons with respect to the primary vehicle, means to compute dynamic polygons with respect to the primary vehicle, means to compare points of the multivariate probability distribution with segments of the vehicle-referenced fixed and dynamic polygons, means to use the multivariate probability distribution points, vehicle referenced segments of the polygons and vehicle operation to determine vehicle operation modifications, means to send vehicle operation control commands to the primary vehicle via the electrical interface, means to perform and send redundant control commands to the primary vehicle via the electrical interface, means to send alerts to the display unit, means to send alerts to mobile communication devices, means to confirm correct system operation, means to detect fail-safes and tampering, and means to store and analyze mobile communication device historical data.

(Error Predictor) Another aspect of the system is a method for processing over-the-air metadata between the plurality of radio communication devices on the primary vehicle and the plurality of mobile communication devices to efficiently correlate present conditions with compiled historic records to estimate accuracy and improve the OTA protocol and computation of a multivariate probability distribution.

(Radio System Communications) Another aspect of the invention is an OTA protocol where a plurality of mobile communication devices generate indiscriminate radio frequency pulses or blink messages to initiate communication with the plurality of primary vehicle radio communication devices. The primary vehicle radio communication devices report they heard the mobile communication device(s) along with the associated metadata. The system runs the error predictor algorithm by using machine learning techniques or continually capturing ground truth data and identifying the source of errors for determining predicted error of ranging between mobile communication devices and primary vehicle radio communication devices. The command unit prioritizes the top four radio communication devices by most accurate primary vehicle radio metadata and selects the radio communication device with the least predicted error for communication with the mobile communication device. Message transfer is performed between the primary vehicle's strongest communication device and the mobile communication device with content and instructions for two-way ranging. The response from the mobile communication device follows the 802.15.4z protocol with double-sided two-way ranging messages to the four primary vehicle radio communication devices selected by the command unit. Lastly, the primary radio communication devices communicate time-of-flight (ToF) information directly or indirectly with TDoA to the command unit for processing.

The mobile communication device sends blink messages, receives a schedule and dictates a timing protocol for the mobile communication device and primary vehicle radio communication devices along with dictating the acceptable receive windows for the mobile communication device. It also leads to a receive window for a plurality of primary vehicle radio communication devices. The plurality of radio communication devices mounted on the primary vehicle initially communicates with any mobile communication device detected by receiving blink messages and passing information to the command unit for analysis and determination of a communication schedule with the mobile communication device. The command unit communicates with the plurality of radio communication devices mounted on the primary vehicle and upon receiving data from the plurality of radio communication devices, selects four of the radio communication devices from the plurality of radio communication devices to be used for two-direction two-way ranging or time-of-flight communication and creates a calendar for that communication between radio communication devices and the mobile communication devices. Upon direction from the command unit, the plurality of primary vehicle radio communication devices execute the previously scheduled calendar by communicating with the mobile communication devices. The mobile communication devices support communication with each primary vehicle radio communication device in executing the previously scheduled calendar.

(Digital Twin) Another aspect of the invention is the ability to compute digital twin(s) for each mobile communication device and each primary vehicle radio communication device. This aspect includes means for anticipating OTA schedule for the mobile communications device and scheduling the four primary vehicle radio communication devices within the OTA schedule.

(Statistically Computed Multivariate Probability Distribution) Another aspect of the invention is the ability for the command unit to statistically compute probabilistic distributions representing the mobile communication devices. This aspect uses the timestamps and metadata returned from TWR by each of the primary vehicle radio communication devices and calculates a ToF directly or indirectly with TDoA. Additionally, the command unit predicts error of ToF based on the TWR metadata and combines the predicted error with the estimated distance to compute a probabilistic distribution representing and/or approximating the mobile communication device, referred to as a multivariate probability distribution.

(Points of the Multivariate Probability Distribution) Additional calculations compute points of the multivariate probability distribution for comparison with segments/thresholds of the fixed and dynamic polygons with respect to the primary vehicle. The options include an algorithm that computes the geometric center of the multivariate probability distribution, an algorithm to compute points on at least one of the probability contour line of the multivariate probability distribution that delineates a specific probability, an algorithm to stochastically choose points of the multivariate probability distribution, and/or any other methods for computing points of the multivariate probability distribution.

(Primary Vehicle Fixed Polygons) The system is configured with fixed polygons referenced to the primary vehicle where the primary vehicle is no longer moving to avoid contact with any mobile communication device. There are multiple fixed polygons referenced to the primary vehicle. The system monitors the primary vehicle to determine direction and as the primary vehicle changes direction, the algorithm updates the fixed polygons referenced to the primary vehicle.

(Primary Vehicle Dynamic Polygons) The system can dictate throttle settings and monitor the primary vehicle to determine velocity. Combining those inputs along with the primary vehicle's direction, and without regard to the size or dimensions of the vehicle, a system algorithm computes dynamic polygons as an extension of the fixed polygons.

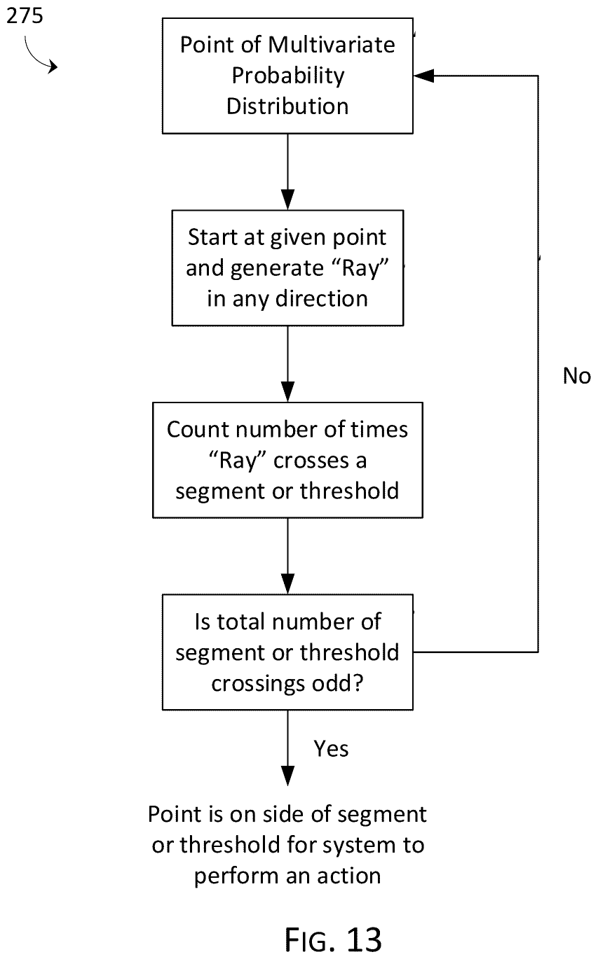

(Comparison Algorithm) The system includes an algorithm to compare the points of the multivariate probability distribution with segments/thresholds of the fixed or dynamic polygons with respect to the primary vehicle. If any of the points approaches/encroaches upon any of the polygons, the algorithm determines an appropriate action to limit vehicle operation. If action is required, the command unit communicates with the control unit to slow, stop or allow primary vehicle acceleration. FIG. 13 explains a representative process 275 for comparing one or more multivariate probability distribution points with one or more of the segments/thresholds of the fixed and dynamic polygons. For example, a point of the multivariate probability distribution representing the first asset is selected. A “ray” is generated in any direction from the selected point. The system counts the total number of segments/thresholds crossed by the “ray”. When the total number of segment/threshold crossings is an odd number, the selected point is on the side of the segment/threshold for the system to perform an action (e.g., alerting, braking, stopping, etc.) When the total number of segment/threshold crossings is an even number, then the system takes no action.

(Vehicle Control Algorithm) The system includes multiple methods for controlling the primary vehicle. The first method is if any of the points of the multivariate probability distribution encroaches on any of the warning policy threshold segments, a motor de-acceleration sequence initiates. The warning policy is a set of conditions under which the system takes action without attempting to immediately stop the vehicle. The conditions of the warning policy expand on the conditions of the stopped and stopping policies, but are intended to alert the operator and surrounding personnel of possible danger. Since the braking function of some vehicles can introduce physical risk, the warning policy includes efforts to limit the acceleration to slow the vehicle and also to alert the operator that braking may follow. Another method is if all the points of the multivariate probability distribution are no longer detected as approaching or encroaching on the warning policy threshold segments, the system initiates a motor acceleration sequence. Another method is if any of the points of the multivariate probability distribution encroaches on the stopping policy threshold segments, the system initiates an emergency braking sequence. The stopping policy is a set of conditions under which the system must activate the braking function of a moving vehicle. The conditions of the stopping policy expand on the conditions of the stopped policy, accounting for the braking distance, time delays, and other related properties of the braking system. The system initiates the stop or braking sequence to ensure the vehicle has sufficient time to come to a complete stop in order to meet the stopped policy requirements. Another method is if any of the points of the multivariate probability distribution encroaches on any of the stopped policy polygons, the system keeps the primary vehicle emergency brakes engaged. The stopped policy is a set of conditions under which the vehicle must be stopped or prevented from moving. These conditions are specified as a collection of safety thresholds relative to the vehicle, which an applicable tag (e.g., first asset) is prohibited from encroaching. There are also conditional parameters defining if the safety thresholds are applicable to a tag. These conditional parameters may include mode of operation, direction of travel, and tag role. The system is configurable to incorporate new conditional parameters as the operational environment develops. Another method is if all of the points of the multivariate probability distribution are no longer detected as approaching or encroaching on the stopping or stopped policy threshold segments, the system de-activates the emergency brake. In embodiments, the operator can alternatively or in addition be alerted to take the corrective action recommended by the system and/or can intervene if other action is appropriate.

(Control Unit) The system includes a control unit that communicates with the command unit and display unit. The control unit also interfaces with the primary vehicle controls to manage operation using redundant methods. The control unit senses vehicle controls and assists with system configuration and diagnostics. Additionally, the control unit generates status messages and warning indicators. The control unit also measures primary vehicle acceleration with a sensor to confirm primary vehicle acceleration and de-acceleration. The control unit also includes a method to detect if the mechanical emergency braking system effectively stopped or is stopping the primary vehicle by utilizing detailed measurements from an onboard accelerometer.

(Vehicle Control Algorithm and Interface) The system includes a method to limit velocity of the primary vehicle through motor braking, a method to stop the primary vehicle through motor braking, a method to stop the primary vehicle through emergency braking, a method to stop the vehicle by removing power, a method to detect direction of primary vehicle travel, a method to sense the throttle level, and a method to sense direction and angle of steering.

(Display Unit) The system includes a display unit that communicates with the command unit and the control unit. The control unit includes an LCD, menu buttons, an override button, a maintenance lock switch, a radio communication device, and a method for generating warnings.

(User Interface) The control unit communicates with the command unit to initiate commands to modify primary vehicle operation. The control unit communicates with the display unit to display alerts and notifications. The user interface can include the ability for users of the system to pair the mobile communication devices with the primary vehicle system and/or provide for primary vehicle system configuration and diagnostics, as well as provide other methods for user interaction.

(Sensor Warning) The primary vehicle radio communication devices communicate with the command unit and generate visual alarms when directed by the command unit.

(Tag Warning) The command unit communicates with the primary vehicle radio communication devices to send alerts to mobile communication devices. The mobile communication devices drive audible and visual indicators based on the alerts.

(UI) The primary vehicle display unit communicates with the command unit and the control unit to pair mobile communication devices with the primary vehicle system, for primary vehicle system configuration and diagnostics and other methods for user interaction with the primary vehicle system.

(Memory Storage) The system includes several forms of memory including volatile and non-volatile. The system transfers data out of non-volatile memory into volatile memory for execution. The system allocates blocks of volatile memory for program variables and temporary data storage. The command unit stores code, configuration information, and logs of the radio communication and vehicle control system in non-volatile memory. The system reads the configuration files to control how the system behaves.

(Power Distribution) The system includes power supplies, regulation and a distribution network to obtain power from the primary vehicle and propagate throughout the system on the primary vehicle for operation.

(Tag Enclosure) An enclosure containing the mobile communication device is designed for durability in the rugged environment while allowing radio signals and light to pass for proper radio communication and alerts. The enclosure is also designed to allow audible alerts to propagate from inside the enclosure with sufficient volume for detection by the user. The enclosure forms are designed for various applications including stand-alone operation, a radio handset, and devices worn by people such as cap lamps.

(Sensor Enclosure) An enclosure containing the primary vehicle radio communication device is designed for durability in the rugged environment while allowing radio signals and light to pass for proper radio communication and alerts. The enclosure is also designed with a cavity for potting all internal circuitry providing additional durability while supporting intrinsic safety certification.

(Primary Vehicle Type) The radio communication and vehicle control system is designed with configuration management capabilities to support primary vehicle types including non-articulating frames with or without moving components and articulating frames with or without moving components.

(Redundant Controls-Motor, E-brake) The system provides redundant stopping methods by motor braking or emergency braking. Motor braking is gentler on the user and primary vehicle and can stop the vehicle on its own. If this method fails and the system detects the primary vehicle is not stopping correctly, the emergency braking system is initiated to stop the vehicle.

(Failsafes/Tampering) Another aspect of the system are components and methods that determine if the wiring between the command unit and control unit to the primary vehicle are intentionally or unintentionally modified comprising an emergency stop circuit to detects tampering, a throttle slowdown circuit to detect tampering a method for calibration and compensation of electrical differences between vehicles providing a consistent return to velocity movement, and automatic error codes for tampering and equipment failure sent to display unit.

(System Proper Operation) Another aspect of the system is power and communication monitoring on each primary vehicle system component and between primary vehicle system components to ensure proper system operation.

(Historical Tag Monitoring) Another aspect of the system is the ability of the radio communication system to store information for additional metadata historical analysis. This provides the ability to store information from each of a plurality of primary vehicle communication devices and a plurality of mobile communication device blinks and TWR. The command unit compiles the combined data including the device blinks and TWR to determine direction and velocity of the primary vehicle.

(Machine States) Based on the configuration management of the primary vehicle type, a large array of states exists as combinations of possible frame articulation and/or component movement. State inputs may be discrete (motor is active or not) or continuous (rate of motor activity). The system accounts for these states by modifying the fixed and/or dynamic polygons. As the primary vehicle articulates and/or activates components, the system adjusts by recalculating fixed and/or dynamic polygon properties as a function of machine state inputs and associated configuration parameters. Calculated fixed and/or dynamic polygon properties include but are not limited to activation, scale, rotation, and translation.

(TDoA) Time difference of arrival is used to indirectly estimate the ToF using individual messages. Each message is sent by one node and received by multiple nodes, then the timestamps of the received messages are compared. These comparisons allow indirect estimation of the ToF, refining and reinforcing the mobile-related multivariate probability distribution in conjunction with other direct or indirect ToF estimates.

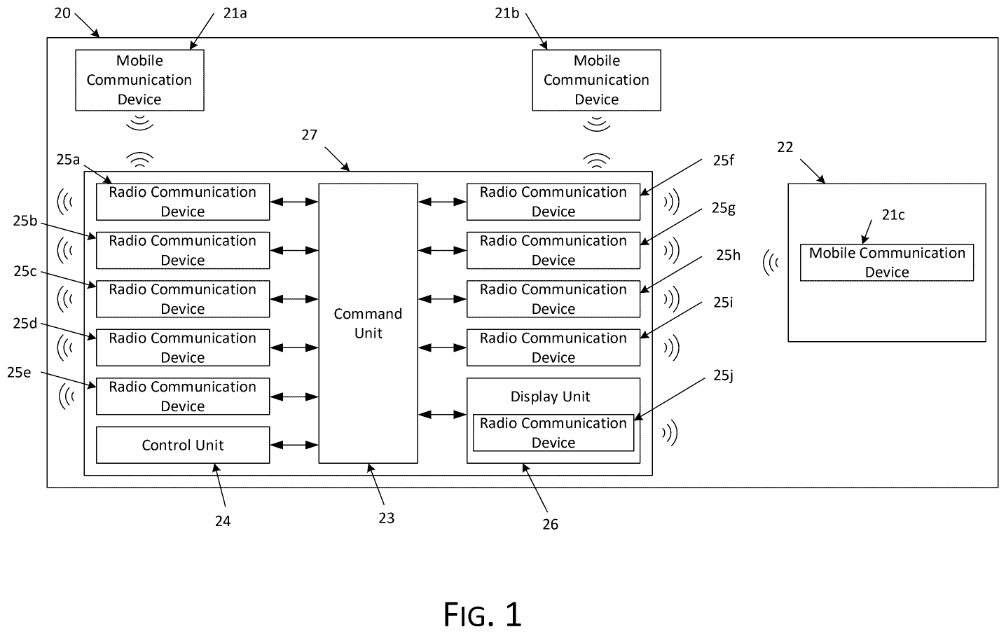

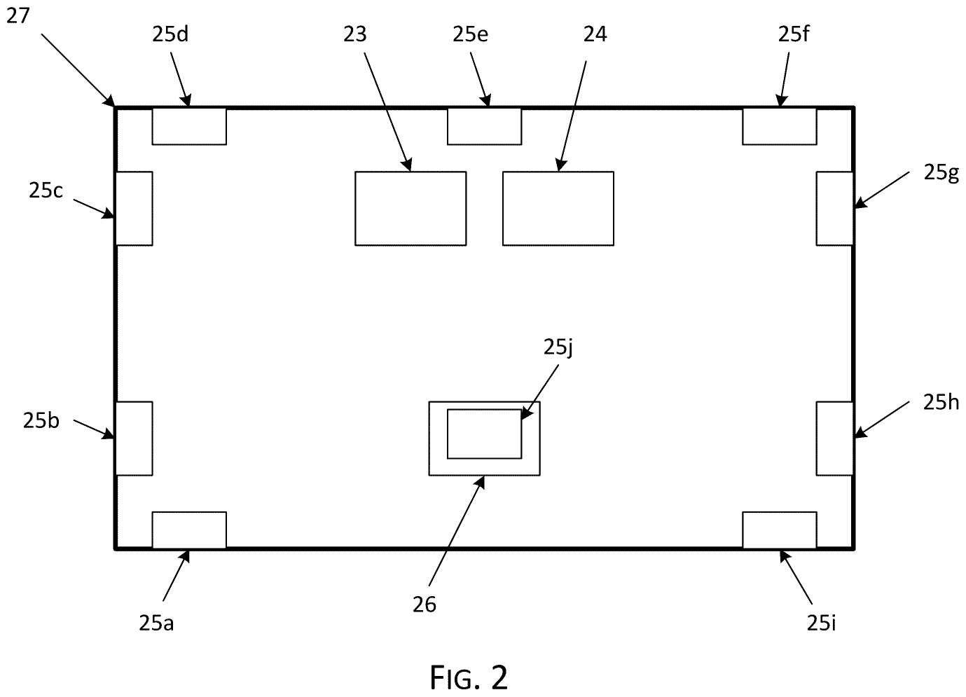

(System & Method Overview) FIG. 1 shows a radio communication and vehicle control system according to embodiments of the invention, comprising a radio communication system and mobile communication devices. FIG. 2 shows a primary vehicle mounted radio communication system comprising multiple radio communication devices, a command unit, a control unit, and a display unit.

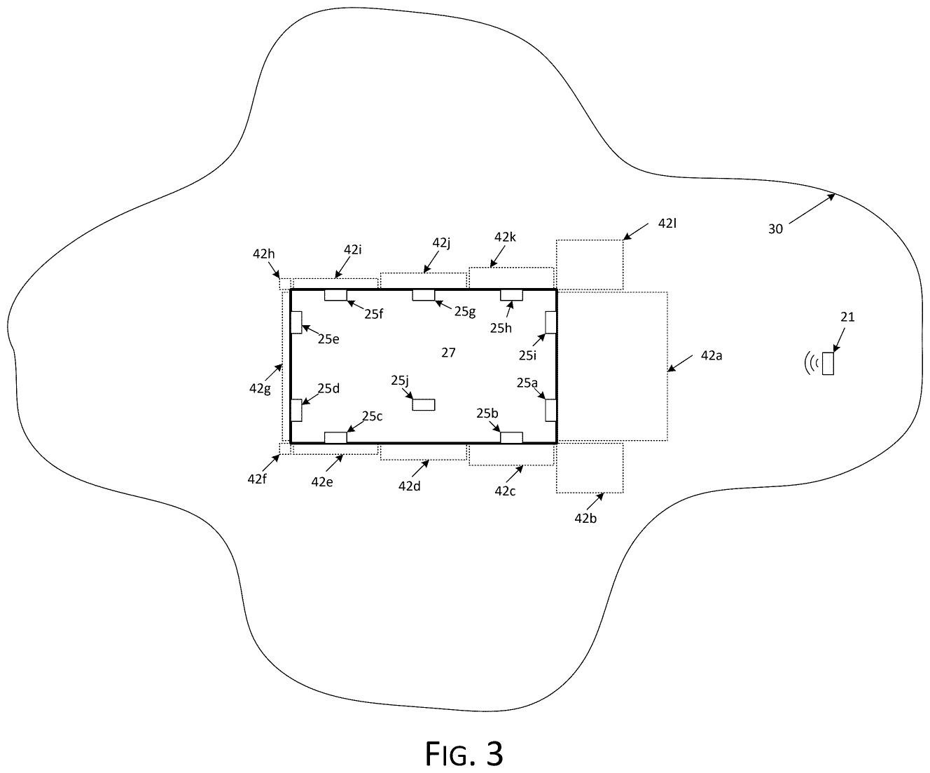

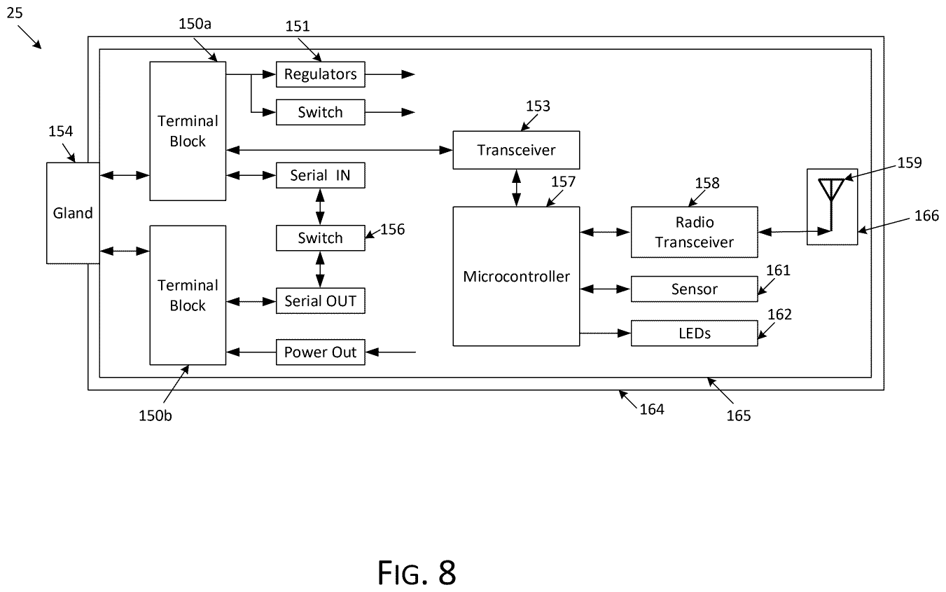

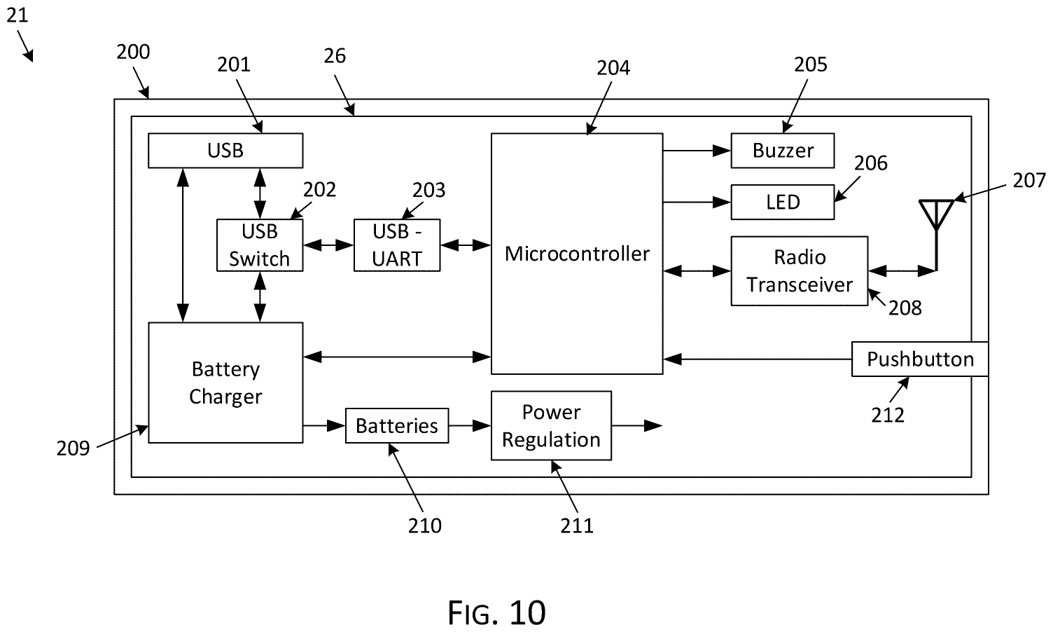

More particularly, FIG. 1 and FIG. 2 show a radio communication and vehicle control system 20 providing for wireless communication between one or more or multiple mobile communication devices 21a-21c and multiple primary vehicle radio communication devices 25a-25j. According to embodiments of the invention, the multiple vehicle radio communication devices 25a-25j are configured to detect the presence of one or more or multiple mobile communication devices 21a-21c once any mobile communication device 21a-21c is within radio coverage 30 (FIG. 3) of the primary vehicle 27. The radio coverage 30 is a property of the radio communication device 25a-25j properties, mobile communication device 21a-21c properties, antennas 159, 207 (FIGS. 8 and 10), and surrounding environment. The radio communication and vehicle control system 20 uses information from the wireless communication to effect change on the primary vehicle 27 with various movements such as one or more of acceleration, de-acceleration, emergency stopping, and/or steering. In embodiments, the radio communication and vehicle control system 20 enables the primary vehicle 27 movements to be used for applications including contact avoidance, autonomous vehicle control, tele-remote, safety and production efficiency. The one or more mobile communication devices 21a-21c are typically mounted or worn by any object including people (e.g., 21a), fixed locations or equipment (e.g., 21b) or mobile equipment 22, such as a secondary vehicle (e.g., 21c).

(System & Methods) The radio communication and vehicle control system 20 includes i) multiple radio communication devices 25a-25j mounted at various locations on the primary vehicle 27 (see, e.g., FIG. 2), ii) one or more command unit 23, one or more control unit 24, and one or more display unit 26 mounted on the primary vehicle 27. The radio communication and vehicle control system 20 also includes mobile communication devices 21a-21c (including the same or various types of devices). The radio communication devices 25a-25j and mobile communication devices 21a-21c form the basis of the wireless communication of the radio communication and vehicle control system 20.

In embodiments, the one or more mobile communication devices 21a-21c initiate a wireless over-the-air (OTA) communication with one or more of the radio communication devices 25a-25j mounted on the primary vehicle 27 and support ongoing wireless communication to pass information back and forth with the multiple radio communication devices 25a-25j. The mobile communication devices 21a-21c have several physical forms to support various applications.

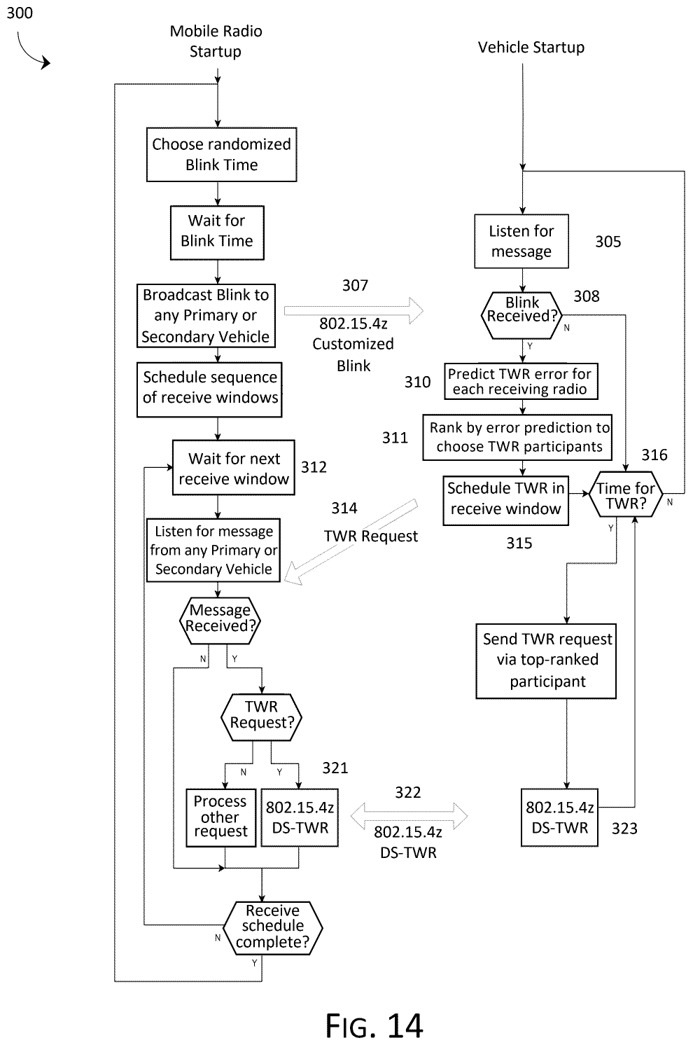

(Error Predictor) The radio communication system (comprising multiple radio communication devices 25a-j, a command unit 23, a control unit 24, and a display unit 26) of the radio communication and vehicle control system 20 is mounted on a primary vehicle 27. During use, the multiple radio communication devices 25a-25j are exposed to a significant amount of obstructions and signal reflections that could lead to errors. The radio communication and vehicle control system 20 processes OTA metadata between the multiple radio communication devices 25a-25j and the one or more or multiple mobile communication devices 21a-21c to efficiently identify how to improve the OTA protocol 300 (see, e.g., FIG. 14) and computation of a multivariate probability distribution. One way to minimize the amount of error is by using machine learning techniques to analyze large numbers of datasets to better identify obstructions and signal reflections along with associated errors. Another way to minimize the amount of error is to collect large amounts of data and manually compare with ground truth to better classify signals with obstructions and reflections along with associated errors. This may be presented to the radio communication and vehicle control system 20 as a model or simple look-up.

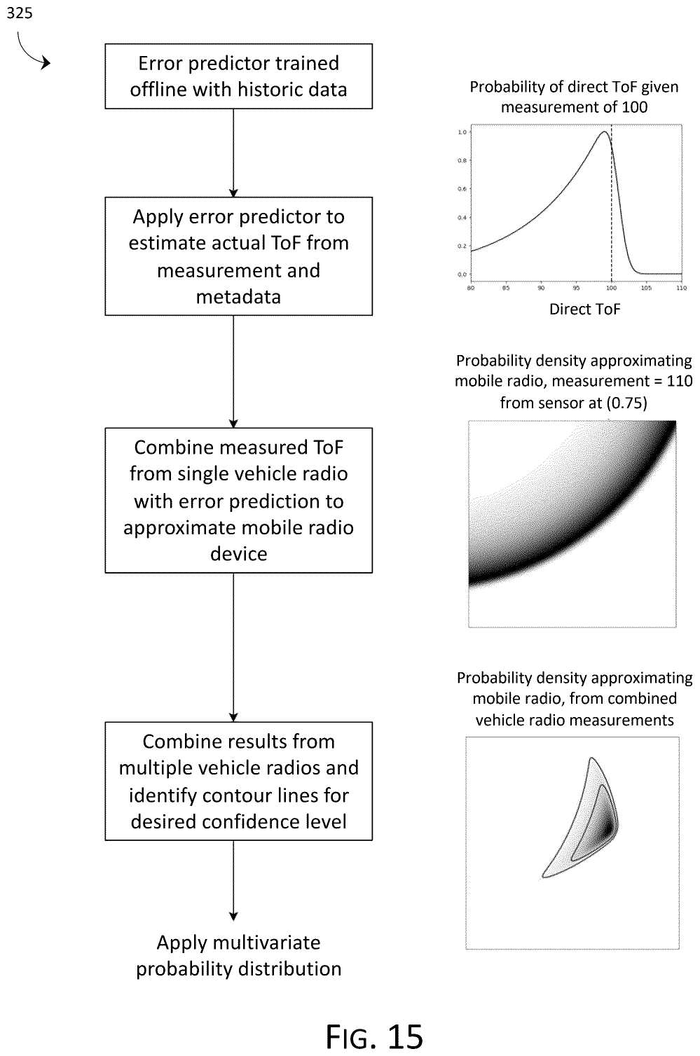

(Radio System Communications) As illustrated in FIG. 14, another aspect of embodiments of the invention is an OTA protocol 300 where the one or more or multiple mobile communication devices 21a-21c generates asynchronous radio frequency pulses in the form of a blink message 307 to initiate communication with the multiple radio communication devices 25a-25j. The multiple radio communication devices 25a-25j mounted on the primary vehicle 27 listen for a blink 307 during any idle time, collect metadata for any received blink 307, and report the receipt with metadata to the command unit 23. The radio communication and vehicle control system 20 runs the error predictor algorithm 325 (see, e.g., FIG. 15) on reported metadata to predict error of ranging between one or more of the mobile communication devices 21a-21c and the multiple radio communication devices 25a-25j.

The command unit 23 analyzes each radio communication device's 25a-25j metadata and prioritizes the top four radio communication devices 25a-25j by most accurate, then selects the radio communication device 25a-25j with the least predicted error for communication with the one or more mobile communication device 21a-21c. The blink event 307 initiates a predefined sequence of receive opportunities 305, 308, 310, 311, 315, 316, wherein the primary vehicle 27 may transmit messages 314 to the one or more mobile communication device 21a-21c via the radio communication devices 25a-25j. The command unit 23 randomly selects a receive window 312, 315 and requests the mobile communication device 21a-21c commences two-way ranging 322 during the same receive window 312, 315.

The response from the mobile communication device 21a-21c follows the 802.15.4z protocol 321-323 with double-sided two-way ranging messages 322 to the top four primary vehicle 27 radio communication devices 25a-25j selected by the command unit 23. The two-way ranging sequence 322 uses 802.15.4z standard messages, customized to include time-of-flight (ToF) data directly or indirectly with TDoA along with metadata about the two-way ranging sequence 322. The radio communication devices 25a-25j collect data and metadata from these messages along with data and metadata from local operations, and send this to the command unit 23 for processing.

(Digital Twin) The command unit 23 has the processing power and software designed to compute digital twin(s) for each mobile communication device 21a-21c and each radio communication device 25a-25j. This capability allows the command unit 23 to anticipate the OTA schedule for the one or more mobile communications device 21a-21c and more efficiently schedule the top four radio communication devices 25a-25j within the OTA schedule.

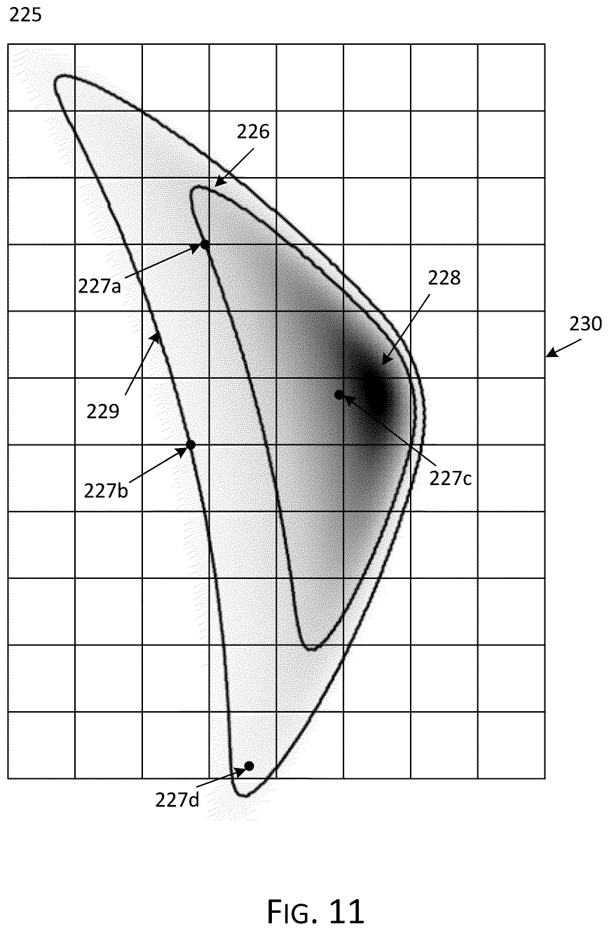

(Mobile-Related Multivariate Probability Distribution) The command unit 23 uses the OTA metadata to compute a multivariate probability distribution 225 (FIG. 11) representing each of the mobile communication devices 21a-21c. The command unit 23 uses the timestamps and metadata returned from TWR by each of the multiple radio communication devices 25a-25j and calculates a ToF directly with TWR or indirectly with TDoA. The command unit 23 predicts error 325 (FIG. 15) for each ToF, then combines the predicted error 325 with the estimated distance to compute a multivariate probability distribution 225 (FIG. 11) representing the probability distribution with respect to the mobile communication device 21a-21c. A vector approach or a rasterized equation as shown here may be used to update a previous estimate with each new measurement:

$$P ( \vec{x} \vert {m}_{i} ) = \frac{P ( {m}_{i} \vert \vec{x} ) \cdot P ( \vec{x} )}{P ( {m}_{i} \vert \vec{x} ) \cdot P ( \vec{x} ) + P ( {m}_{i} \vert - \vec{x} ) \cdot P ( - \vec{x} )}$$

Where:
\vec{x}:=Vector representing mobile radio (each 2D of 3D voxel under consideration)
P(\vec{x}):=Prior belief of probability for location \vec{x}
P(−\vec{x}):=Prior probability of locations other than \vec{x}
mᵢ:=Newly measured ToF from vehicle radio to mobile radio
P(mᵢ|\vec{x}):=Probability of measuring mᵢ for location \vec{x}
P(mᵢ|−\vec{x}):=Probability of measuring mᵢ for locations other than \vec{x}
P(\vec{x}|mᵢ):=Probability of location \vec{x}. after accounting for new measurement mᵢ
   The highest probability of the multivariate probability distribution 225 is shown with a higher concentration of data 228. In embodiments, a machine learning model is trained to determine a multivariate probability distribution, such as multivariate probability distribution 225, from raw data/metadata.

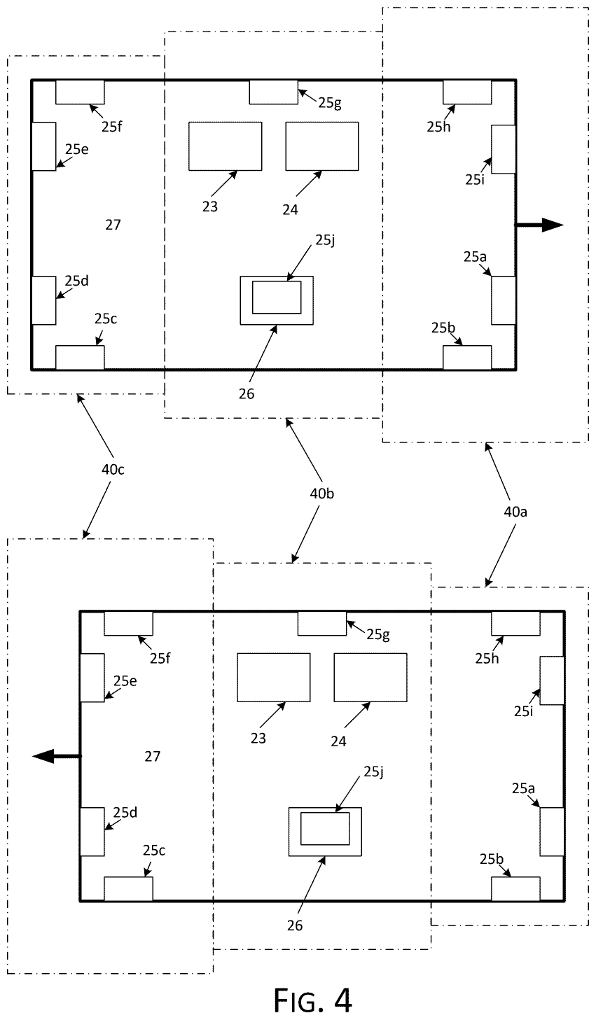

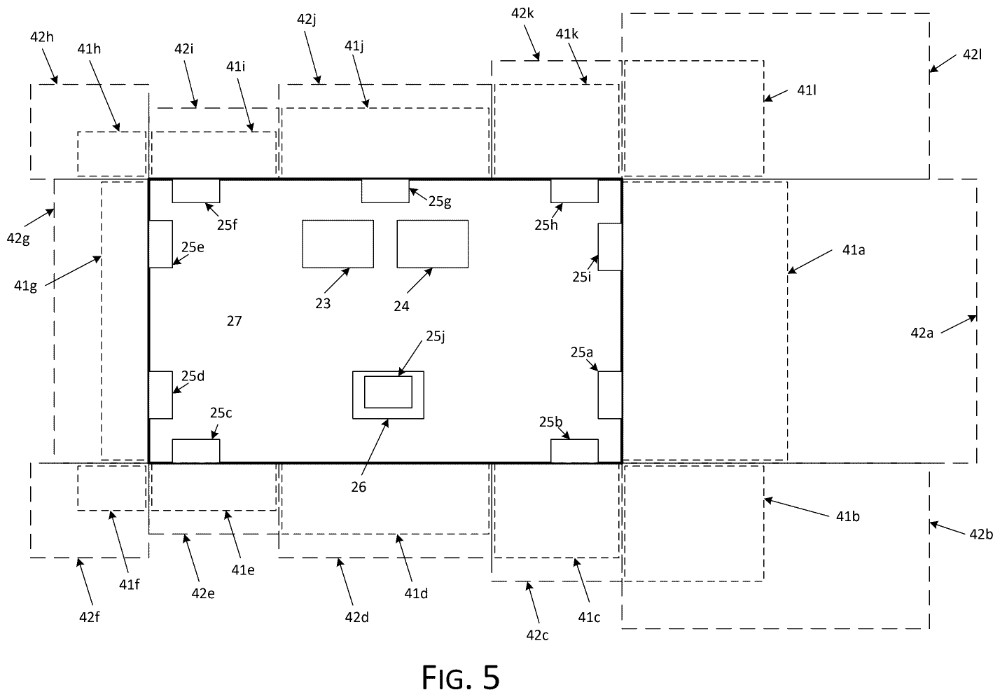

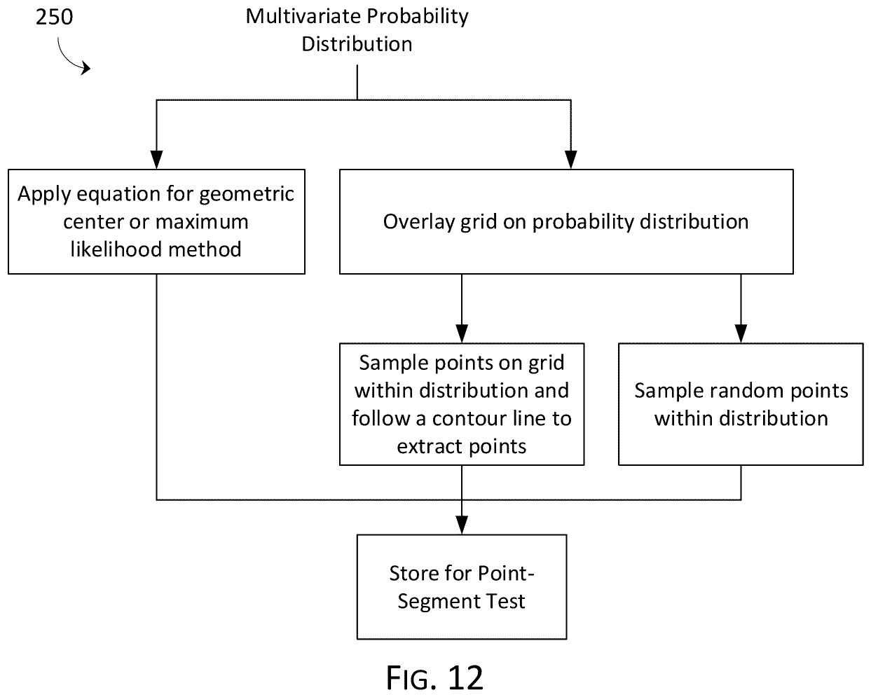

(Points of the Multivariate Probability Distribution) The radio communication and vehicle control system 20 requires computed points 227a-227d for comparison with the fixed 40a-40c (FIG. 4) and dynamic polygons 41a-41l and 42a-42l (FIG. 5) with respect to the primary vehicle 27. As shown in FIG. 11 and FIG. 12, the command unit 23 computes one or more or multiple points 227a-227d of the multivariate probability distribution 225 for the comparison. The first point algorithm 250 (FIG. 12) used by the command unit 23 is a point computation representing the geometric center 227c of the multivariate probability distribution 225.

$${C}_{x} = \frac{{\sum }_{i} {C}_{i x} {A}_{i}}{{\sum }_{i} {A}_{i}} , {C}_{y} = \frac{{\sum }_{i} {C}_{i y} {A}_{i}}{{\sum }_{i} {A}_{i}} .$$

Where the probability distribution is broken into some number of smaller shapes then computing the geometric center (C) and area (A) of each part then computing a combined Cₓ, C_{y}. The command unit 23 can also identify point 227c using the maximum likelihood method.

$${\vec{x}}_{max} = arg {max}_{\vec{x}} P ( \vec{x} \vert {m}_{i} )$$

Where xₘₐₓ is the vector having maximum likelihood on the multivariate probability distribution P.
The command unit 23 also identifies points 227a-227d on the probability contour lines 226, 229 of the multivariate probability distribution 225 that delineates a specific probability. This is accomplished by superimposing the probability distribution on a grid 230 and selecting any number of points 227a-227b along one of the probability contour lines 226, 229 to extract x, y coordinates. The command unit 23 can also stochastically choose points 227a-227d within the multivariate probability distribution 225 and is able to extract them using a grid 230. The command unit 23 has sufficient processing capabilities to compute points 227a-227d of the multivariate probability distribution 225 using other algorithms.

(Primary Vehicle Fixed Polygons) The command unit 23 stores the user configured fixed polygons 40a-40c based on location reference of the primary vehicle 27. The radio communication and vehicle control system 20 uses the fixed polygons 40a-40c to ensure the primary vehicle 27 is no longer moving to avoid contact with any mobile communication device 21a-21c. The radio communication and vehicle control system 20 monitors the primary vehicle 27 to determine direction, and as the primary vehicle 27 changes direction, the command unit 23 updates the fixed polygons 40a-40c referenced to the primary vehicle 27.

(Primary Vehicle Dynamic Polygons) The radio communication and vehicle control system 20 can dictate throttle settings and monitor the primary vehicle 27 to determine velocity. Combining those inputs along with the primary vehicle's 27 direction, the command unit 23 computes dynamic polygons 41a-41l and 42a-42l as an extension of the fixed polygons 40a-40c. Multiple polygons 42a-42l with respect to the primary vehicle 27 use motor braking to de-accelerate or re-accelerate. Another set of polygons 41a-41l with respect to the primary vehicle 27 use the emergency brake for complete de-acceleration to a stop.

(Comparison Algorithm) The command unit 23 uses the previously computed points 227a-227d of the multivariate probability distribution 225 and compares these points with segments of the fixed polygons 40a-40c and segments of the dynamic polygons 41a-41l and 42a-42l with respect to the primary vehicle 27. Using the process 275 (FIG. 13), if the point 227a-227d is calculated as encroaching on any of the segments, the command unit 23 determines an appropriate action to limit vehicle 27 operation. If action is required, the command unit 23 communicates with the control unit 24 to slow, stop or allow primary vehicle 27 acceleration.

(Vehicle Control Algorithm) The radio communication and vehicle control system 20 is connected to multiple primary vehicle 27 controls including throttle, power, emergency brake, and other wired interfaces. If any of the statistically computed points 227a-227d encroach on segments of the warning policy polygons 42a-42l, the command unit 23 and control unit 24 work together to compute the amount of motor de-acceleration required and initiate the sequence. If all of the statistically computed points 227a-227d are no longer detected as encroaching on the segments of the warning policy polygons 42a-42l, the command unit 23 and control unit 24 coordinate to initiate a motor acceleration sequence. If any of the statistically computed points 227a-227d encroach on the stopping policy segments of the polygons 41a-41l, the command unit 23 and control unit 24 initiate an emergency braking sequence. If any of the points 227a-227d computed of the multivariate probability distribution 225 encroach on any of the stopped policy segments of polygons 40a-40c, the command unit 23 and control unit 24 keep the primary vehicle 27 emergency brakes engaged. If all the statistically computed points 227a-227d are no longer detected as encroaching on the stopping policy segments of polygons 41a-41l or segments of stopped policy polygons 40a-40c, the radio communication and vehicle control system 20 de-activates the emergency brake.

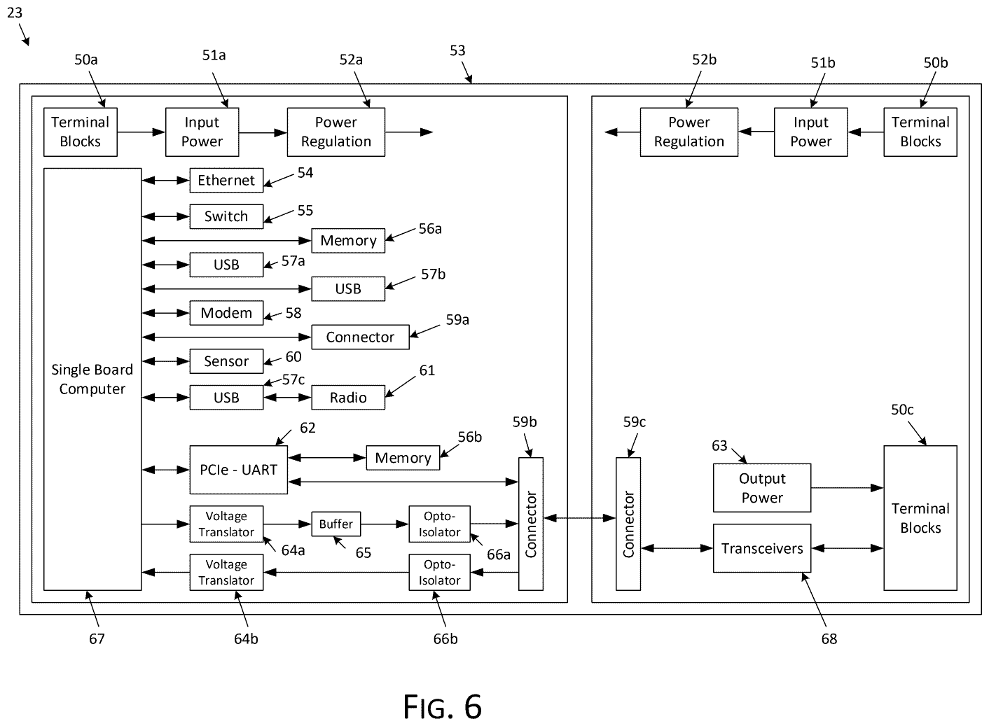

(Command Unit) As shown in FIG. 6, the command unit 23 is the primary processing core of all components mounted on the primary vehicle 27. It includes memory/storage 56a-56b/67 and processing capabilities for coordinating wired communication amongst all primary vehicle 27 mounted equipment. The command unit 23 includes a single board computer 67, sensor communication hub 62, sensor power source/distribution 63, display unit 26, control unit 24 communication 68, display unit 26 communication 68, movement sensor 60, and two wireless diagnostic links 58, 61 for radio communication and vehicle control system 20 updates and log retrieval.

A single board computer 67 supports primary processing of the radio communication and vehicle control system 20 and interfacing with most other components on the command unit 23. The command unit 23 includes terminal blocks 50a-50c for physical wiring between the internal circuit boards and the other component(s), such as one or more component(s) of the radio communication system (e.g., one or more radio communication devices 25a-25j mounted on primary vehicle 27 in FIG. 1) and vehicle control system 20. Due to command unit 23 enclosure 53 constraints, the command unit 23 has at least one circuit board with connectors 59a-59c for board interface (e.g., inter-board connectors).

The radio communication and vehicle control system 20 is standalone but interfaces wirelessly to other networks for remote diagnostics, monitoring and data transfer. This is made possible with a radio modem 58 interfacing to the single board computer 67. The command unit 23 provides multiple USB ports 57a-57c for interfacing with multiple peripherals or future add-ons. They are all connected directly to the single board computer 67. An Ethernet port 54 is provided for serial communication with the command unit 23. A switch 55 is included in the command unit 23 for direct interface to the single board computer 67 for testing purposes. The command unit 23 has a serial debug port 59a to assist with board level troubleshooting and ongoing development. A movement sensor 60 is included in the command unit 23 to monitor primary vehicle 27 movement and provide feedback.

The radio communication and vehicle control system 20 supports multiple wired communication protocols where the command unit 23 includes transceivers 68 for communication with the control unit 24 and display unit 26 via one of those wired communication protocols. The command unit 23 includes additional transceivers 68 for wired communications with the radio communication devices 25a-25j. The command unit 23 provides a second radio 61 as an additional wireless interface to the radio communication and vehicle control system 20. The second radio 61 operates in client or host mode to allow local or remote diagnostics, monitoring, and data transfer.

The command unit 23 includes several forms of memory including volatile and non-volatile to support various functions. At startup, the radio communication and vehicle control system 20 transfers data out of non-volatile memory into volatile memory for execution. The radio communication and vehicle control system 20 processes allocate blocks of volatile memory for program variables and temporary data storage for the radio communication and vehicle control system 20. The command unit 23 stores code, configuration information, and logs of the radio communication and vehicle control system 20 in non-volatile memory 56a-56b. The radio communication and vehicle control system 20 reads the configuration files to control how the radio communication and vehicle control system 20 behaves, and these files can be written by the user to support customization. The files are also retrieved and analyzed for performance analysis of the radio communication and vehicle control system 20 and to enable future enhancements of the radio communication and vehicle control system 20.

The primary vehicle 27 typically operates in an intrinsically safe environment where the command unit 23 includes one or more opto-isolators (IS components 66a-66b) to ensure the radio communication and vehicle control system 20 meets the Intrinsically safe requirements. Several opto-isolators 66a-66b are included as barriers between the intrinsically safe and non-intrinsically safe circuits within the command unit 23. A buffer 65 is included for signal conditioning between circuits. Due to the circuit level design requirements to support various interfaces, voltage translators 64a-64b are included to ensure correct command unit 23 operation.

The radio communication and vehicle control system 20 connects to the primary vehicle 27 power and regulates it down to various voltage domains for use by each of the components of the radio communication and vehicle control system 20. For example, the command unit 23 of control system 20 can include several power regulators 52a-52b designed to support each of the previously mentioned circuits, and which are configured to receive power from primary vehicle 27 (and/or another power source) which is provided to command unit 23 as input power 51a-51b.

(Control Unit) The control unit 24 is responsible for monitoring and directly interfacing with the primary vehicle 27 controls. It works in conjunction with the command unit 23 to make decisions and coordinate wired communication amongst all primary vehicle 27 mounted equipment.

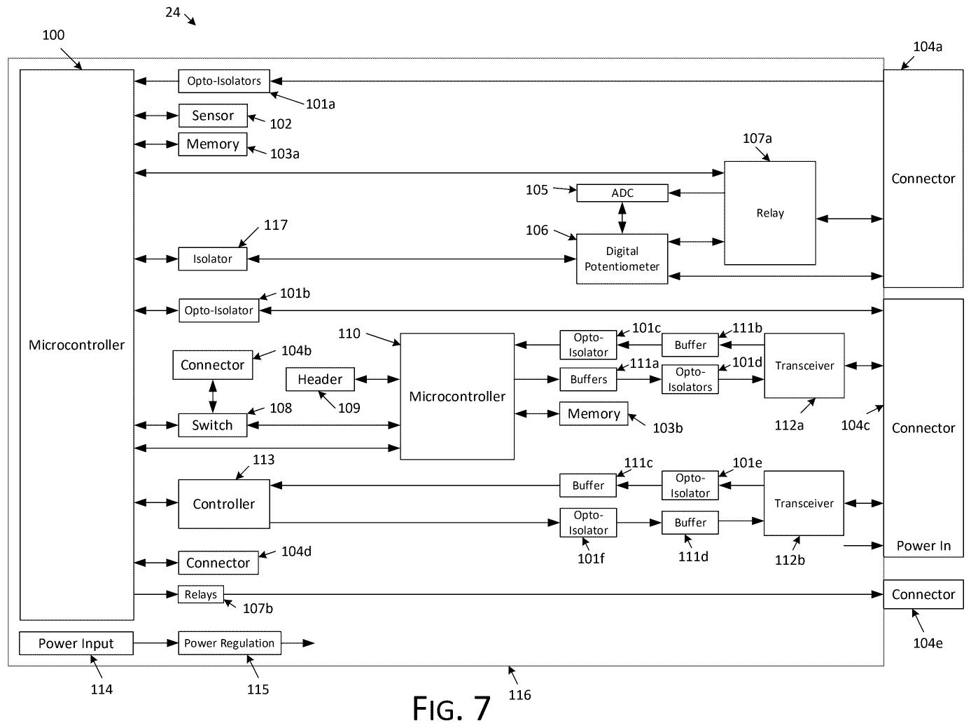

FIG. 7 shows the control unit 24 included in the radio communication and vehicle control system 20 that communicates with the command unit 23 and display unit 26. The control unit 24 includes two microcontrollers 100 and 110, one or more switch 108 and one or more header 109, wired protocol transceivers 112a-112b, memory 103a-103b, a sensor 102, connectors 104a-104e, relays 107a-107b, power 114 and 115, an ADC 105 and a digital potentiometer 106. The control unit 24 also includes circuitry to support an IS approval including buffers 111a-111d, an isolator 117 and opto-isolators 101a-101f.

The first microcontroller 100 supports connections to the second microcontroller 110, one or more sensors 102, a wired communication controller 113, connectors 104a-104e, memory 103a-103b and relays 107a-107b. It also directly connects to an isolator 117 and opto-isolators 101a-101f that support intrinsic safety analysis. The second microcontroller 110 communicates with the first microcontroller 100, and memory 103b along with more buffers 111a-111b and opto-isolators 101c-101d. The two microcontrollers dictate multiple wired communication protocols for interfacing with the command unit 23 and display unit 26. The control unit 24 includes several forms of memory 103a-103b including volatile and non-volatile.

The control unit 24 includes wired protocol transceivers 112b for communication with the control unit 24 and display unit 26. The control unit 24 includes different wired protocol transceivers 112a for communications with the multiple radio communication devices 25a-25j. A communication controller 113 is included to support reliable wired protocol communications with the command unit 23 and display unit 26.

The control unit 24 monitors vehicle controls and assists with the configuration and diagnostics of the radio communication and vehicle control system 20. The control unit 24 also measures primary vehicle 27 movement with a sensor 102 to confirm primary vehicle 27 acceleration and de-acceleration. The control unit 24 also interfaces with the primary vehicle 27 controls to manage operation. Based on communication with the command unit 23, the control unit 24 generates status messages and warning indicators. The control unit 24 also includes the ability to detect if the mechanical emergency braking system effectively stopped or is stopping the primary vehicle 27 by utilizing detailed measurements from an onboard sensor 102. The control unit 24 includes a sensor 102 for motion detection. Based on sensor 102 feedback, the control unit 24 communicates with the command unit 23 to monitor the state of the primary vehicle 27. The control unit 24 is designed with a digital potentiometer 106 that provides fine resolution for primary vehicles 27 with throttle control. The digital potentiometer 106 allows the radio communication and vehicle control system 20 to slowly de-accelerate the primary vehicle 27 to avoid sudden movements felt by the operator and to limit damage to the primary vehicle 27. The control unit 24 interfaces directly with the primary vehicle 27 using relays 107a-107b designed to support the appropriate electrical specifications required by the primary vehicle 27. The control unit 24 includes an ADC for monitoring the throttle position.

Several opto-isolators 101a-101f are included as barriers between the intrinsically safe and non-intrinsically safe circuits within the control unit 24. Several buffers 111a-111d are included for signal conditioning between circuits.

The control unit 24 includes a connector 104b for programming purposes. The control unit 24 includes a connector 104d for manual programming during the production or repair process. The control unit 24 includes a connector 104a installed in the outer enclosure 116 for connecting to internal circuitry and to the primary vehicle 27 VFDs. The control unit 24 includes multiple onboard and enclosure mounted connectors for wired interfacing to the command unit 23, display unit 26 and the primary vehicle 27.

The radio communication and vehicle control system 20 connects to the primary vehicle 27 power and regulates it down to various voltage domains for use by each of the components of the radio communication and vehicle control system 20. The control unit 24 includes several regulators 115 designed to support each of the previously mentioned circuits.

(Radio Communication Device) As shown in FIG. 8, the multiple radio communication devices 25 (e.g., 25a-25j) are designed with one or more circuit boards combined and mounted inside a thermoplastic polymer enclosure 164. The enclosure 164 has a compartment designed for mounting the boards then screwing on a backplate with a hole to insert potting for stability and intrinsic safety analysis. A gland 154 is mounted on the backplate to allow cable access which carries power and communication conductors. Two terminal blocks 150a-150b are included on the circuit board which provide a mechanically secure connection for the cable conductors. The movement sensor 161 aids in monitoring primary vehicle 27 direction and velocity changes.

The wired protocol of the multiple radio communication devices 25a-25j is a loop architecture where each radio communication device 25a-25j has specific conductors that transmits/receives data from the command unit 23. It is possible for multiple radio communication devices 25a-25j to operate on the same bus where each radio communication device 25a-25j has a wired communication protocol switch 156 to allow communication to the subsequent radio communication devices 25a-25j on that bus. Each radio communication device 25a-25j includes a microcontroller 157 for communications with the command unit 24 and a transceiver 153 for communication with mobile communication devices 21a-21c. The microcontroller 157 dictates when the radio transceiver 158 is in receive or transmit mode and controls the messaging content as directed by the command unit 23. The microcontroller 157 drives the visual indicators 162 (e.g., LEDs) to support primary vehicle 27 polygon segment/threshold policy enforcement. Each radio communication device 25a-25j has a unique radio transceiver 153 that supports wired communication with the onboard microcontroller 157 and wireless communication through the onboard antenna 159 with one or more or a plurality of mobile communication devices 21a-21c. The transceiver sends and receives precision timing signaling and digital messaging. Each of the multiple radio communication devices 25a-25j has a broadband antenna circuit board 159 designed to support the wide range of frequencies used by the radio communication and vehicle control system 20 for wireless communication. The antenna pattern for a given application typically involves a narrow or wide beam width. Based on the application, an antenna ground plane board 166 is included at a pre-determined distance behind the broadband antenna circuit board 159 to assist with narrowing the antenna pattern and increasing the gain.

The radio communication and vehicle control system 20 obtains power from the command unit 23 and regulates it down to various voltage domains for use by each of the components of the radio communication and vehicle control system 20. The multiple radio communication devices 25a-25j include several regulators 151 designed to support each of the previously mentioned circuits.

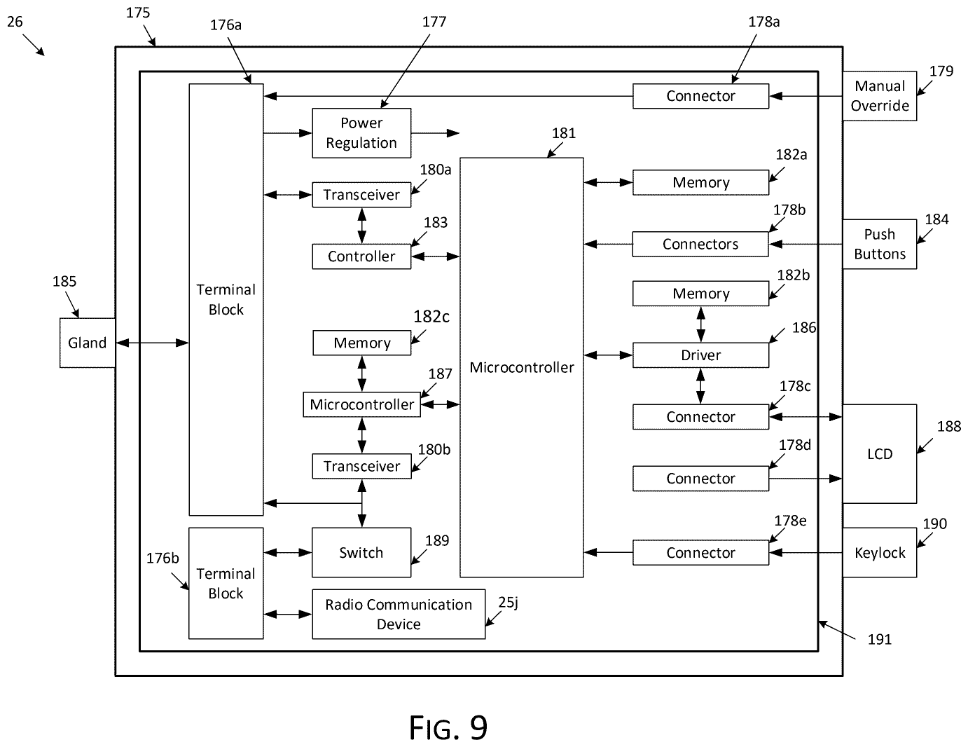

(Display Unit) FIG. 9 shows the radio communication and vehicle control system 20 which includes a display unit 26 that communicates with the command unit 23 and the control unit 24. The display unit 26 is primarily responsible for interaction with users to provide information including diagnostics and warnings. Additionally, it provides direct, wired input from users to the radio communication and vehicle control system 20 of the primary vehicle for various functions including configuration and pairing with one or more or multiple mobile devices 21a-21c. The display unit 26 includes an LCD 188, at least one circuit board, menu buttons 184, an override button 179, a keylock switch 190, a radio communication device 25j, and the ability to generate warnings.

The display unit 26 enclosure 175 is designed for mounting internal circuit boards along with supporting peripherals 179,184,188,190 then bolting to the primary vehicle's 27 chassis. A gland 185 is mounted on the side of the enclosure 175 to allow cable access which carries power and communication conductors. Two terminal blocks 176a-176b are included on the circuit board which provide a mechanically secure connection for the cable conductors. The first terminal block 176a interfaces between the display unit 26 and radio communication and vehicle control system 20 and the second connects a radio communication device PCB 165 to the circuit board 191. One of the display unit 26 microcontrollers 181 interfaces with the second microcontroller 187, a wired protocol controller 183, a driver 186, connectors 178a-178e and memory 182a-182c. The second microcontroller 187 focuses on interfacing between the first microcontroller 181 and the wired communication protocol circuitry 180a, 183.

The display unit also includes two wired protocol transceiver ICs 180a-180b that support communication with the command unit 23 and control unit 24. The display unit 26 includes a wired communication protocol switch 189 to allow wired communication access to the internal radio communication device 165. The display unit 26 includes multiple connectors 178a-178e for connection to the peripheral components such as the manual override 179, push buttons 184, LCD 188 and keylock 190. A display driver 186 is used as an interface between the first microcontroller 181 and the LCD 188.

The display unit 26 includes several forms of memory including volatile and non-volatile to support various functions. At startup, the radio communication and vehicle control system 20 transfers data out of non-volatile memory into volatile memory for execution. The radio communication and vehicle control system 20 processes allocate blocks of volatile memory for program variables and temporary system 20 data storage.

The display unit 26 includes several push buttons 184 for user interaction including direct interface with the radio communication and vehicle control system 20 to pair with the one or more or multiple mobile communication devices 21a-21c or check configuration settings. The display unit 26 includes an LCD 188 to improve the user experience. It displays information of the radio communication and vehicle control system 20 to the user. Some functions of the radio communication and vehicle control system 20 may employ appropriate permissions where a keylock 190 is provided to ensure the correct users have appropriate access. The radio communication and vehicle control system 20 provides a manual override input 179 that overrides normal system functions of the radio communication and vehicle control system 20 but only lasts for a pre-determined amount of time.

The radio communication and vehicle control system 20 connects to the primary vehicle 27 power and regulates it down to various voltage domains for use by each of the components of the radio communication and vehicle control system 20. The display unit 26 includes several regulators 177 designed to support each of the previously mentioned circuits.

(Mobile Communication Device) FIG. 10 shows an embodiment of the mobile communication device 21a-21c, which includes a microcontroller 204, radio transceiver 208, antenna 207, USB port 201, USB switch 202, batteries 210, battery charger 209, buzzer 205, LED 206 and power regulation 211. The microcontroller 204 controls when the radio transceiver 208 is in receive or transmit mode and controls the messaging content. The microcontroller 204 controls the visual and audio indicators that indicate region violation status, battery capacity, and charging state. The ID is stored in microcontroller 204 memory.

Each mobile communication device 21a-21c has a unique radio transceiver 208 that supports wired communication with the onboard microprocessor 204 and wireless communication through the onboard antenna 207 with the multiple radio communication devices 25a-25j. The transceiver sends and receives precision timing signaling and digital messaging. Each of the multiple radio communication devices 25a-25j has a broadband antenna circuit board 207 designed to support the wide range of frequencies used by the radio communication and vehicle control system 20 for wireless communication.

The momentary pushbutton switch 212 is a logic input to the microcontroller 204 and can be configured for different behavior depending on application needs. The mobile communication device 21a-21c includes a buzzer 205 to sound when an audible alert is necessary. The mobile communication device 21a-21c includes an LED 206 to light when a visual alert is necessary.

The mobile communication device 21a-21c includes a USB port 201 for battery charging, device configuration, programming and device debugging. A USB switch 202 is included to support wired communication between the external USB port 201, the microcontroller 204 and the internal battery charging circuitry 209. The mobile communication device 21a-21c supports USB and UART communications where a USB to UART translator 203 is included.

The mobile communication device 21a-21c includes a battery charger 209 that recharges the internal NiMH battery 210 when an external USB power source is connected to the USB port 201. The mobile communication device 21a-21c includes a rechargeable NiMH battery 210. The mobile communication device 21a-21c obtains power from the internal batteries and regulates it to various voltage domains for use by each of the onboard components. The mobile communication device 21a-21c includes several regulators 211 designed to support each of the previously mentioned circuits.

(Vehicle Control Algorithm and Interface) The radio communication and vehicle control system 20 includes a method to limit velocity of the primary vehicle 27 through motor braking, a method to stop the primary vehicle 27 through motor braking, a method to stop the primary vehicle 27 through emergency braking, a method to stop the primary vehicle 27 by removing power, a method to detect direction of primary vehicle 27 travel, a method to sense the throttle level, and a method to sense direction and angle of steering. One or more of these methods can be used separately or combined to control primary vehicle 27.

(User Interface) The control unit 24 communicates with the command unit 23 to initiate commands to modify primary vehicle 27 operation.

The control unit 24 communicates with the display unit 26 to display alerts and notifications.

The primary vehicle 27 display unit 26 communicates with the command unit 23 and the control unit 24 to assign roles with associated privileges to mobile communication devices 21a-21c, for primary vehicle system 20 configuration and diagnostics and other methods for user interaction with the primary vehicle system 20.

(Sensor Warning) The multiple primary vehicle radio communication devices 25a-25j communicate with the command unit 23 and generate visual alarms when directed by the command unit 23.

(Tag Warning) The command unit 23 communicates with the multiple primary vehicle radio communication devices 25a-25j to send alerts to one or more mobile communication devices 21a-21c.

The one or more mobile communication devices 21a-21c drive audible and visual indicators based on the alerts.

(Memory Storage) The radio communication and vehicle control system 20 in embodiments includes several forms of memory including volatile and non-volatile to support various functions.

At startup, the radio communication and vehicle control system 20 transfers data out of non-volatile memory into volatile memory for execution. The radio communication and vehicle control system 20 processes allocate blocks of volatile memory for program variables and temporary system data storage.

Memory 56a-56b of the radio communication and vehicle control system 20 is used to store code, configure information, and store system logs. The radio communication and vehicle control system 20 reads the configuration files to control how the radio communication and vehicle control system 20 behaves, and these files can be written by the user to support customization. The files are also retrieved and analyzed for system performance analysis and to enable future system enhancements of the radio communication and vehicle control system 20.

(Power Distribution) The radio communication and vehicle control system 20 includes power supplies, regulation and a distribution network to obtain power from the primary vehicle 27 and propagate throughout the radio communication and vehicle control system 20 on the primary vehicle 27 for operation.

(Tag Enclosure) As shown in FIG. 10, an enclosure 200 containing the mobile communication device 21a-21c is designed for durability in the rugged environment while allowing radio signals and light to pass for proper radio communication and alerts. The enclosure 200 is also designed to allow audible alerts to propagate from inside the enclosure 200 with sufficient volume for detection by the user. The enclosure 200 forms are designed for various applications including stand-alone operation, a radio handset, and devices worn by people such as cap lamps.

(Sensor Enclosure) As shown in FIG. 8, an enclosure 164 containing a radio communication device 25a-25j of the primary vehicle 27 is designed for durability in the rugged environment while allowing radio signals and light to pass for proper radio communication and alerts. The enclosure 164 is also designed with a cavity for potting all internal circuitry providing additional durability while supporting intrinsic safety certification.

(Primary Vehicle Type) The radio communication and vehicle control system 20 is designed with configuration management capabilities to support primary vehicle 27 types including non-articulating frames with or without moving components and articulating frames with or without moving components.

(Redundant Controls—Motor, E-brake) The control unit 24 includes a variable resistance to the throttle circuit, which automatically applies a very low resistance to the throttle circuit when going into the emergency stop mode, and acts as a redundant method of stopping. A motion measurement sensor 102 detects if the secondary slowdown stopping method is required during a live emergency stop.

(Failsafes/Tampering) The radio communication and vehicle control system 20 includes components and algorithms to determine if the wiring between the command unit 23 and control unit 24 to the primary vehicle 27 are intentionally or unintentionally modified comprising an emergency stop circuit to detects tampering. A throttle slowdown circuit is included to detect tampering along with an algorithm for calibration and compensation of electrical differences between vehicles providing a consistent return to velocity movement. The radio communication and vehicle control system 20 also includes automatic error codes for tampering and equipment failure sent to display unit 26.

(System Proper Operation) The radio communication and vehicle control system 20 includes power and communication monitoring on each component of the radio communication and vehicle control system 20 and between the components of the radio communication and vehicle control system 20 to ensure proper system operation.

(Historical Tag Monitoring) The radio communication and vehicle control system 20 includes processing 67 and memory 56a-56b to store metadata of the radio communication and vehicle control system 20 for historical analysis. This capability allows the radio communication and vehicle control system 20 to store information from each of the multiple radio communication devices 25a-25j and all mobile communication devices 21a-21c including blink 307 and TWR data. The command unit 23 compiles the combined data including device blinks 307 and TWR to determine direction and velocity.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Any of the methods disclosed herein can be used with any of the systems disclosed herein or with any other system, and vice versa. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. A radio communication and vehicle control system, comprising:
at least one mobile communication device;
a plurality of radio communication devices in association with a primary vehicle;
a command unit comprising storage and processing capabilities for:
i) communication between the plurality of radio communication devices;
ii) performing an approximation of the at least one mobile communication device and selecting one or more points therein;
iii) preparing fixed and/or dynamic polygons relative to the primary vehicle and selecting one or more segments thereof; and
iv) comparing one or more of the selected points with one or more of the segments to determine point-segment encroachment or non-encroachment;
a control unit capable of operable communication with the command unit and one or more controls of the primary vehicle, the control unit configured to:
a) cause braking of the primary vehicle;
b) release braking of the primary vehicle; and/or
c) accelerate the primary vehicle.

2. The system of claim 1, further comprising an alert display unit in operable communication with the command unit and the control unit.

3. The system of claim 1, wherein:
the approximation is a statistical approximation;
the one or more selected points are statistical points; and
the approximation comprises a multivariate probability distribution approximating the at least one mobile communication device.

4. The system of claim 3, wherein:
the point-segment encroachment or non-encroachment determination comprises comparing the one or more selected statistical points, which are statistical points of the multivariate probability distribution, with a threshold.

5. The system of claim 4, wherein:
the encroachment is determined by non-compliance with the threshold; or
the non-encroachment is determined by compliance with the threshold.

6. The system of claim 5, wherein:
based on the non-compliance with the threshold, the command unit is configured to communicate with the control unit to slow or stop the primary vehicle.

7. The system of claim 5, wherein:
based on the compliance with the threshold, the command unit is configured to communicate with the control unit to accelerate or release a brake of the primary vehicle.

8. The system of claim 1, wherein:
the braking involves motor braking of the primary vehicle;
the braking is capable of decelerating or stopping the primary vehicle;
the braking involves an emergency brake of the primary vehicle; and/or
the release involves releasing a brake, the motor braking, or the emergency brake.

9. The system of claim 8, wherein the braking or the release involves one or more algorithm(s).

10. The system of claim 9, wherein:
the algorithm(s) for motor braking, decelerating, releasing the motor braking or accelerating compare multiple statistically computed points to the segments of the dynamic polygons to ensure the multiple statistically computed points do not encroach upon one or more segments of the fixed polygons; and
the control unit enables engagement of an emergency brake of the primary vehicle in response to one or more of the statistically computed points encroaching upon one or more segment of the fixed polygons.

11. The system of claim 1, wherein the command unit:
is capable of computing multiple polygons by extending the fixed polygons as the primary vehicle changes direction and/or velocity.

12. A contact avoidance system comprising:
a mobile communication device capable of being disposed on a first asset;
a radio communication system comprising a plurality of sensors capable of being disposed on a primary vehicle;
a control unit; and
a command unit configured to:
i) execute a two-direction two-way ranging or time-of-flight protocol between a subset of the plurality of sensors and the mobile communication device;
ii) compute a multivariate probability distribution approximating the first asset, compare calculated points of the multivariate probability distribution with a threshold, and determine threshold non-compliance; and
iii) based on the threshold non-compliance, communicate with the control unit to slow or stop the primary vehicle.

13. The contact avoidance system of claim 12, wherein:
one or more of the plurality of sensors are capable of listening for and performing ongoing communications with the mobile communication device; and
the mobile communication device is capable of generating radio frequency messages or blinks for reception by the plurality of sensors.

14. The contact avoidance system of claim 12, wherein:
the plurality of sensors comprises at least four sensors configured to communicate time-of-flight (ToF) information with time difference of arrival (TDoA) to the command unit.

15. The contact avoidance system of claim 12, wherein the command unit:
is capable of calculating an estimated ToF with TDoA of TWR (two way ranging) timestamps;
is capable of predicting error of estimated ToF with TDoA based on TWR metadata;
is capable of combining the predicted error with the estimated ToF with TDoA to compute a multivariate probability distribution representing the probability distribution of the location of the at least one mobile communication device.

16. The contact avoidance system of claim 12, wherein the command unit further comprises one or more of:
an algorithm that computes a point with maximum likelihood of the multivariate probability distribution; or
an algorithm to compute points on, within, of, or from probability contour lines of the multivariate probability distribution that delineates a specific probability; or
an algorithm to stochastically choose points on, within, of, or from the multivariate probability distribution.

17. The contact avoidance system of claim 12, wherein the command unit comprises storage and processing capabilities for:
preparing fixed and/or dynamic polygons relative to the primary vehicle and selecting one or more segments thereof; and
comparing one or more of the calculated points of the multivariate probability distribution with one or more of the segments to determine point-segment encroachment or point-segment non-encroachment.

18. The contact avoidance system of claim 12, wherein the command unit comprises storage and processing capabilities for:
initiating motor de-acceleration in response to point-segment encroachment of warning policy polygons;
initiating motor acceleration in response to point-segment non-encroachment;
initiating emergency braking in response to point-segment encroachment of stopping policy polygons;
initiating locking of the primary vehicle by way of an emergency brake in response to point-segment encroachment of stopped policy polygons; and/or
de-activating the emergency brake in response to no point-segment encroachment of the stopping or stopped policy polygons.

19. The contact avoidance system of claim 12, wherein the primary vehicle comprises a non-articulating frame or an articulating frame, with or without moving components.

20. The contact avoidance system of claim 12, wherein the mobile communication device is configured for mounting on a person or on a secondary vehicle.
